(19) United States
(12) Patent Application Publication
(10) Pub. No.: US 2025/0159654 A1
(43) Pub. Date: May 15, 2025

(54) PAGING AND SYSTEM INFORMATION (SI) PROCEDURES UNDER ADJUSTED SYNCHRONIZATION SIGNAL BLOCK MEASUREMENT TIME CONFIGURATION (SMTC) IN NON-TERRESTRIAL NETWORKS (NTN)

(71) Applicant: TELEFONAKTIEBOLAGET LM ERICSSON (PUBL), STOCKHOLM (SE)

(72) Inventors: Ming Li, Stockholm (SE); Muhammad Ali Kazmi, Reston, VA (US)

(21) Appl. No.: 18/838,597

(22) PCT Filed: Feb. 14, 2023
(86) PCT No.: PCT/IB2023/051339

§ 371 Date: Aug. 14, 2024

Related U.S. Application Data
(60) Provisional application No. 63/309,768, filed on Feb. 14, 2022.

(51) Int. Cl. H04W 68/02; H04W 24/08; H04W 24/10

(52) U.S. Cl. CPC H04W 68/02; H04W 24/10; H04W 24/08

(57) ABSTRACT

Methods, apparatuses, and computer-readable media are disclosed for configuring a User Equipment (UE) to perform measurements of a Reference Signal (RS) transmitted by cells which are served or managed by satellite nodes or Non-Terrestrial Network (NTN) nodes. In some embodiments, a method is performed by a UE for a wireless access network that includes determining whether the UE meets one or more Adjusted RS occasion-Channel reception resource Proximity (ARCP) conditions for an RS Occasion (RSO) and a Channel Reception Resource (CRR). The method further includes performing one or more operational tasks based on whether the UE meets the one or more ARCP conditions for the RSO and the CRR. In some embodiments, the performing the one or more operational tasks comprises adapting at least one measurement scaling factor to a measurement time to extend the measurement time. Corresponding embodiments of a UE are also disclosed.

### RELATED APPLICATIONS

This application claims the benefit of provisional patent application Ser. No. 63/309,768, filed Feb. 14, 2022, the disclosure of which is hereby incorporated herein by reference in its entirety.

### TECHNICAL FIELD

The present disclosure relates to methods, apparatuses, and systems for enabling satellite communications in cellular networks.

### BACKGROUND

There is an ongoing resurgence of satellite communications. Several plans for satellite networks have been announced in the past few years. Satellite networks could complement mobile networks on the ground by providing connectivity to underserved areas and multicast/broadcast services.

To benefit from the strong mobile ecosystem and economy of scale, adapting the terrestrial wireless access technologies including Third Generation Partnership Project (3GPP) Long Term Evolution (LTE) and New Radio (NR) for satellite networks is drawing significant interest, which has been reflected in the 3GPP standardization work.

In 3GPP Release 15, the first release of the Fifth Generation (5G) System (5GS) was specified. This is a new generation's radio access technology intended to serve use cases such as enhanced Mobile Broadband (eMBB), Ultra-Reliable and Low Latency Communication (URLLC), and massive Machine Type Communication (mMTC). The 5GS includes the NR access stratum interface and the 5G Core Network (5GC). The NR physical and higher layers reuse parts of the Long Term Evolution (LTE) specification, and to that add needed components when motivated by new use cases. One such component is the introduction of a sophisticated framework for beam forming and beam management to extend the support of the 3GPP technologies to a frequency range going beyond 6 Gigahertz (GHz).

In Release 15, 3GPP started the work to prepare NR for operation in a Non-Terrestrial Network (NTN). The work was performed within the study item “NR to support Non-Terrestrial Networks” and resulted in the 3GPP Technical Report (TR) 38.811 (see, e.g., V15.4.0). In Release 16, the work to prepare NR for operation in an NTN network continued with the study item “Solutions for NR to support Non-Terrestrial Network” (see 3GPP TR 38.821, e.g., V16.1.0).

### 1. Satellite Characteristics

A satellite radio access network usually includes the following components:
A satellite that refers to a space-borne platform.
An earth-based gateway that connects the satellite to a base station or a core network, depending on the choice of architecture.
Feeder link that refers to the link between a gateway and the satellite.
Access link, or service link, that refers to the link between a satellite and a UE.

Depending on the orbit altitude, a satellite may be categorized as low earth orbit (LEO), medium earth orbit (MEO), or geostationary earth orbit (GEO) satellite.
LEO: typical heights ranging from 250-1,500 kilometers (km), with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

Two basic architectures can be distinguished for satellite communication networks, depending on the functionality of the satellites in the system:
Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the next-generation Node B (gNB) is located on the ground and the satellite forwards signals/data between the gNB and the User Equipment (UE).
Regenerative payload. The satellite includes on-board processing to demodulate and decode the received signal and regenerate the signal before sending it back to the earth. When applied to the general 3GPP architecture and terminology, the regenerative payload architecture means that the gNB is located in the satellite.

In the work item for NR NTN in 3GPP release 17, only the transparent payload architecture is considered.

A satellite network or satellite based mobile network may also be called a Non-Terrestrial Network (NTN). On the other hand, a mobile network with base stations on the ground may be called a terrestrial network (TN) or a non-NTN network. A satellite within an NTN may be called a NTN node, NTN satellite, or simply a satellite.

FIG. 1 shows an example architecture of a satellite network, or NTN, with bent pipe transponders (i.e., the transparent payload architecture). The base station (e.g., gNB) may be integrated in the gateway or connected to the gateway via a terrestrial connection (wire, optic fiber, wireless link).

A communication satellite typically generates several beams over a given area. The footprint of a beam is usually has an elliptical shape, which has traditionally been considered as a cell, but cells with the coverage footprint of multiple beams are not excluded in the 3GPP work. The footprint of a beam is often referred to as a spotbeam. The footprint of a beam may move over the earth's surface with the satellite movement or may be earth fixed with a beam pointing mechanism used by the satellite to compensate for the satellite's motion (where the latter may be referred to as quasi-earth-fixed beams or quasi-earth-fixed cells). The size of a spotbeam depends on the system design, which may range from tens of kilometers to a few thousands of kilometers.

In a LEO or MEO communication system, a large number of satellites deployed over a range of orbits are required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive Internet of Things (IoT) services with relaxed latency requirements, it may not even be necessary to support full earth-coverage. It may be sufficient to provide occasional or periodic coverage according to the orbital period of the constellation.

A 3GPP device in the RRC_IDLE or RRC_INACTIVE (RRC is Radio Resource Control) state is required to perform a number of procedures including measurements for mobility purposes, paging monitoring, logging measurement results, tracking area update, and search for a new Public Land Mobile Network (PLMN) to mention a few. These procedures will consume power in devices, and a general trend in 3GPP has been to allow for relaxation of these procedures to prolong device battery life. This trend has been especially pronounced for IoT devices supported by reduced capability (redcap), Narrowband IoT (NB-IoT), and LTE Machine Type Communication (LTE-M).

Propagation delay is an important aspect of satellite communications that is different from the delay expected in a terrestrial mobile system. For a bent pipe satellite network, the round-trip delay may, depending on the orbit height, range from tens of milliseconds in the case of LEO satellites to several hundreds of milliseconds for GEO satellites. As a comparison, the round-trip delays in terrestrial cellular networks are typically below 1 millisecond (ms).

The distance between the UE and a satellite can vary significantly, depending on the position of the satellite and thus the elevation angle, ε, seen by the UE. Assuming circular orbits, the minimum distance is realized when the satellite is directly above the UE (ε=90°), and the maximum distance when the satellite is at the smallest possible elevation angle. Table 1 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 1
Propagation delay for different orbital heights and elevation angles.

| | | | One-way | Propagation |
|---|---|---|---|---|
| Orbital | Elevation | Distance | propagation | delay |
| height | angle | UE <-> satellite | delay | difference |
| 600 km | 90° | 600 km | 2.0 ms | — |
| | 30° | 1075 km | 3.6 ms | 1.6 ms |
| | 10° | 1932 km | 6.4 ms | 4.4 ms |
| 1200 km | 90° | 1200 km | 4.0 ms | — |
| | 30° | 1999 km | 6.7 ms | 2.7 ms |
| | 10° | 3131 km | 10.4 ms | 6.4 ms |
| 35786 km | 90° | 35786 km | 119.4 ms | — |
| | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 microseconds (μs) every second, depending on the orbit altitude and satellite velocity.

### 2. SSB-MTC and Measurement Gaps

The NR Synchronization Signal (SS) consists of Primary SS (PSS) and Secondary SS (SSS). NR Physical Broadcast Channel (PBCH) carries very basic system information. The combination of SS and PBCH is referred to as Synchronization Signal Block (SSB) in NR. Multiple SSBs are transmitted in a localized burst set (i.e., a SS burst set). Within an SS burst set, multiple SSBs can be transmitted in different beams. The transmission of SSBs within a localized burst set is confined to a 5 ms window. The set of possible SSB time locations within an SS burst set depends on the numerology which in most cases is uniquely identified by the frequency band. The SSB periodicity can be configured from the value set {5, 10, 20, 40, 80, 160} ms (where the unit used in the configuration is subframe, which has a duration of 1 ms).

A UE does not need to perform measurements with the same periodicity as the SSB periodicity. Accordingly, the SSB Measurement Time Configuration (SMTC) has been introduced for NR. The signaling of SMTC window informs the UE of the timing and periodicity of SSBs that the UE can use for measurements. The SMTC window periodicity can be configured from the value set {5, 10, 20, 40, 80, 160} ms, matching the possible SSB periodicities. The SMTC window duration can be configured from the value set {1, 2, 3, 4, 5} ms (where the unit used in the configuration is subframe, which has a duration of 1 ms).

The UE may use the same Radio Frequency (RF) module for measurements of neighboring cells and data transmission in the serving cell. Measurement gaps allow the UE to suspend the data transmission in the serving cell and perform the measurements of neighboring cells. The measurement gap repetition periodicity can be configured from the value set {20, 40, 80, 160} ms, the gap length can be configured from the value set {1.5, 3, 3.5, 4, 5.5, 6, 10, 20} ms. Usually, the measurement gap length is configured to be larger than the SMTC window duration to allow for RF retuning time. Measurement gap time advance is also introduced to fine tune the relative position of the measurement gap with respect to the SMTC window. The measurement gap timing advance can be configured from the value set {0, 0.25, 0.5} ms.

FIG. 2 provides an illustration of an SSB, SMTC window, and a measurement gap.

### 3 System Information (SI)

System information provides UEs with essential information, such as cell access information and common radio resource configuration. A UE is required to acquire system information for a cell before making an attempt to access the cell.

System information consists of several information blocks. In NR, the system information consists of a Master Information Block (MIB) and one or more System Information Blocks (SIBs). There are several SIBs (e.g., SIB1, SIB2, . . . ) according to the information type.

Some system information may also be provided on-demand, i.e., upon a request from a UE, e.g., based on Random Access Channel (RACH) or Radio Resource Control (RRC), so an additional delay for requesting the on-demand SI may occur prior to receiving the on-demand SI.

MIB is transmitted on the PBCH with SMTC periodicity (or SSB period). SMTC periodicity is configurable by the network, and it is configurable as one of 5, 10, 20, 40, 80, and 160 ms. One example of MIB information is the timing information about when MIB is transmitted. An example of MIB information is:
The system frame number (SFN)
A part of the SS/PBCH block (i.e., SSB) start position where MIB is transmitted within the SS burst (remaining SSB block index).
SSB block is transmitted in the first half of radio frame or second half of radio frame (half-frame timing))
Information of SIB1 scheduling

MIB transmit time interval (TTI) or MIB periodicity is 80 ms. This means the MIB information may change every 80 ms except for SFN. Since SFN changes every 10 ms, the information bits corresponding to SFN changes depending on the transmitted SFN.

SIB1 is transmitted on the Physical Downlink Shared Channel (PDSCH) with a periodicity of 160 ms (called SIB1 transmission periodicity, or SIB1 TTI) and variable transmission repetition periodicity within 160 ms. The default transmission repetition periodicity of SIB1 is 20 ms but the actual transmission repetition periodicity is up to network implementation, which means the network can decide when it transmits SIB1. For SSB and Control Resource Set (CORESET) multiplexing pattern 1, where the network transmits SSB and SIB1 in the same time but in the different frequency, SIB1 repetition transmission period is 20 ms. For SSB and CORESET multiplexing pattern ⅔ where the network transmits SSB and SIB1 in the different time, SIB1 transmission repetition period is the same as the SSB period (or SMTC period). The SIB1 includes information regarding the availability and scheduling (e.g., mapping of SIBs to SI message, periodicity, SI-window size) of other SIBs with an indication whether one or more SIBs are only provided on-demand, and, in that case, the configuration needed by the UE to perform the SI request. PDSCH conveying SIB1 is scheduled by Physical Downlink Control Channel (PDCCH) with SI Radio Network Temporary Identifier (SI-RNTI). When a UE needs to acquire SIB1, the UE monitors PDCCH with SI-RNTI every possible SIB1 transmission occasion. If the UE finds the PDCCH with SI-RNTI, then UE decodes the Downlink Control Information (DCI) in PDCCH and acquires the PDSCH scheduling information such as resource block size, modulation, coding rate, and redundancy version.

Scheduling of other system information such as SIB2 or SIB3 is configured by the network, and the scheduling information is signaled in SIB1. The scheduling information for on-demand SIB may be provided separately upon UE request. SIBs other than SIB1 (i.e., SIBx) are transmitted on the PDSCH. Each SI message is transmitted within periodically occurring time domain windows (referred to as SI-windows, or SI transmission periodicity). Each SI message is associated with an SI-window and the SI-windows of different SI messages do not overlap. That is, within one SI-window only the corresponding SI message is transmitted. An SI message may be transmitted a number of times within the SI-window.

PDSCH conveying SIBx is scheduled by PDCCH with SI-RNTI. When UE needs to acquire SIBx then the UE monitors PDCCH with SI-RNTI scheduled by PDCCH monitoring occasions for SI message, i.e., PDCCH search space for SI. Note it is possible to schedule one or more PDCCH monitoring occasions within one SI-window. If the UE found the PDCCH, the UE decodes downlink control information (DCI) in PDCCH and acquires the PDSCH scheduling information such as resource block size, modulation, coding rate, and redundancy version.

### 4. Monitoring Paging in IDLE/INACTIVE Mode

When a UE is in IDLE/INACTIVE state, the UE monitors PDCCH whose transmission occasions are configured by the gNB every Discontinuous Reception (DRX) cycle. The DRX cycle can be 320 ms, 640 ms, 1280 ms, and 2560 ms. 3GPP Rel-17 extends the DRX to enable longer DRX period, called extended DRX (eDRX). With eDRX, it is possible to extend the DRX cycle up to 2.91 hours.

In NR, the paging occasions are associated with SS burst. There are two possible ways to multiplex SSB and Paging Occasion (PO).
SSB Frequency Domain Multiplexed (FDMed) with PO
SSB Time Domain Multiplexed (TDMed) with PO

The summary of length and periodicity of PDCCH monitoring for different patterns are shown in Table 2.

TABLE 2
Summary of length and periodicity of PDCCH
monitoring for different patterns

| | | Length of | SFN in which | |
|---|---|---|---|---|
| | PDCCH | PDCCH | PDCCH | |
| | Monitoring | Monitoring | Monitoring | |
| | Occasions | Occasion | Occasions are | Carrier |
| Patterns | Interval | per SSB | located | Frequency |
| Pattern 1 | Every 20 ms | 2 | SFN mod 2 = 0 for | FR1, FR2 |
| | | consecutive | all SSBs OR | |
| | | slots | SFN mod 2 = 0 for | |
| | | | some SSBs and | |
| | | | SFN mod 2 = 1 for | |
| | | | others. | |
| Pattern 2/3 | SS burst set | 1 slot | SFN in which SS | FR2 |
| | period | | burst set is | |
| | (5, 10, 20, | | transmitted. (Note: | |
| | 40, 80, 160) | | SS burst set can be | |
| | ms | | transmitted in any | |
| | | | radio frame of SS | |
| | | | burst set period. | |

The Paging Frame (PF) and PO for paging are determined by the following formulae:

SFN for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

The PDCCH monitoring occasions for paging are determined according to pagingSearchSpace as specified in 3GPP TS 38.213 v17.0.0 and firstPDCCH-MonitoringOccasionOfPO and nrofPDCCH-MonitoringOccasionPerSSB-InPO if configured as specified in 3GPP TS 38.331 v16.7.0. When SearchSpaceId=0 is configured for pagingSearchSpace, the PDCCH monitoring occasions for paging are same as for RMSI as defined in clause 13 in 3GPP TS 38.213 v17.0.0.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

When the UE is in either Camped Normally state or Camped on Any Cell state on a cell, the UE shall attempt to detect, synchronize, and monitor intra-frequency, inter-frequency and inter-Radio Access Technology (inter-RAT) cells indicated by the serving cell. For intra-frequency and inter-frequency cells the serving cell may not provide explicit neighbor list but carrier frequency information and bandwidth information only. UE measurement activity is also controlled by measurement rules defined in 3GPP TS 38.304 v16.7.0, allowing the UE to limit its measurement activity.

In Idle/Inactive mode, UE will only wake-up limited times to AGC retuning, monitor paging occasions, perform intra-frequency measurements, and inter-frequency measurements as shown in FIG. 3.

5. Measurement Relaxation with Paging

### 5.1 Measurement and Evaluation of Serving Cell

The UE shall measure the SS Reference Signal Received Power (SS-RSRP) and SS Reference Signal Received Quality (SS-RSRQ) level of the serving cell and evaluate the cell selection criterion S defined in TS 38.304 v16.7.0 for the serving cell at least once every M1*N1 DRX cycle; where:

$$M 1 = 2 if SMTCH periodicity ( TSMTC ) > 20 ms and DRX cycle \leq 0.64 second , otherwise M 1 = 1.$$

The UE filters the SS-RSRP and SS-RSRQ measurements of the serving cell using at least two measurements. Within the set of measurements used for the filtering, at least two measurements are spaced by at least DRX cycle/2.

If the UE has evaluated according to Table 3 in Nserv consecutive DRX cycles that the serving cell does not fulfill the cell selection criterion S, the UE initiates the measurements of all neighbor cells indicated by the serving cell, regardless of the measurement rules currently limiting UE measurement activities.

If the UE in RRC_IDLE has not found any new suitable cell based on searches and measurements using the intra-frequency, inter-frequency, and inter-RAT information indicated in the system information for 10 seconds(s), the UE initiates cell selection procedures for the selected PLMN as defined in 3GPP TS 38.304 v16.7.0.

TABLE 3
Nₛₑᵣᵥ

| | | |
|---|---|---|
| | Scaling Factor | |
| DRX cycle length | (N1) | Nₛₑᵣᵥ [number of DRX |

| [s] | FR1 | FR2^{Note1} | cycles] |
|---|---|---|---|
| 0.32 | 1 | 8 | M1*N1*4 |
| 0.64 | | 5 | M1*N1*4 |
| 1.28 | | 4 | N1*2 |
| 2.56 | | 3 | N1*2 |

^{Note1}:
Applies for UE supporting power class 2&3&4. For UE supporting power class 1 or 5, N1 = 8 for all DRX cycle length.

### 5.2 Measurement and Evaluation of Intra-Frequency Cells

The UE shall not drop a PO regardless of whether the PO and the SSB occur in the same time resources or when they are close to other in time. However, in this case, the measurement time is extended by factor of 1.5 for DRX cycle=0.32 seconds under certain conditions, e.g. when PO and SSB are 20 ms or more apart.

TABLE 4
T_{detect, NR}_{_{—}}_{Intra,} T_{measure, NR}_{_{—}}_{Intra} and T_{evaluate, NR}_{_{—}}_{Intra}

| DRX | | | | | |
|---|---|---|---|---|---|
| cycle | Scaling Factor | | T_{detect, NR}_{_{—}}_{Intra} [s] | T_{measure, NR}_{_{—}}_{Intra} [s] | T_{evaluate, NR}_{_{—}}_{Intra} |
| length | (N1) | | (number of DRX | (number of DRX | [s] (number of |
| [s] | FR1 | FR2^{Note1} | cycles) | cycles) | DRX cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 (28 × | 1.28 × N1 (2 × N1) | 5.12 × N1 (8 × N1) |
| | | | N1) | | |
| 1.28 | | 4 | 32 × N1 (25 × N1) | 1.28 × N1 (1 × N1) | 6.4 × N1 (5 × N1) |
| 2.56 | | 3 | 58.88 × N1 (23 × | 2.56 × N1 (1 × N1) | 7.68 × N1 (3 × N1) |
| | | | N1) | | |

^{Note1}:
Applies for UE supporting power class 2&3&4. For UE supporting power class 1 or 5, N1 = 8 for all DRX cycle length.
Note 2:
M2 = 1.5 if SMTC periodicity of measured intra-frequency cell >20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_{_{—}}ᵢₙₜᵣₐ is expected.

### SUMMARY

Methods, apparatuses, and computer readable media are disclosed for configuring a User Equipment (UE) to perform measurements of a Reference Signal (RS) transmitted by cells which are served or managed by satellite nodes (also referred to herein as Non-Terrestrial Network (NTN) nodes). In some embodiments, a method is performed by a UE for a wireless access network that includes determining whether the UE meets one or more Adjusted RS occasion-Channel reception resource Proximity (ARCP) conditions for an RS Occasion (RSO) and a Channel Reception Resource (CRR). The method further includes performing one or more operational tasks based on whether the UE meets the one or more ARCP conditions for the RSO and the CRR. In some embodiments, the performing the one or more operational tasks includes adapting at least one measurement scaling factor to a measurement time to extend the measurement time. Certain embodiments provide one or more technical advantages including enhancements in trade-offs regarding flexibility, as well as details and methods for realization of particular configurations.

In some embodiments, the determining whether the UE meets the one or more ARCP conditions for the RSO and the CRR includes determining whether the UE meets the one or more ARCP conditions for the RSO and the CRR based on one or more rules.

In some embodiments, the one or more ARCP conditions include: (a) a condition that the RSO overlaps or partially overlaps the CRR in time, (b) a condition that a distance in time between the RSO and the CRR is within a first predefined or configured threshold, (c) a condition that a distance in time between the RSO and the CRR is not greater than a second predefined or configured threshold, (d) a condition that a magnitude of a difference between an RSO start time or an RSO end time of the RSO and a CRR start time or a CRR end time of the CRR is less than or equal to a third predefined or configured threshold, or (e) a combination of any two or more of the conditions (a)-(d).

In some embodiments, the performing the one or more operational tasks based on whether the UE meets the one or more ARCP conditions for the RSO and the CRR includes performing at least one of a first set of operational tasks if the UE does not meet the one or more ARCP conditions for the RSO and the CRR and performing at least one of a second set of operational tasks if the UE meets the one or more ARCP conditions for the RSO and the CRR. In some embodiments, the second set of operational tasks includes transmitting information about an adjustment of the RSO to a network node and transmitting information that the one or more ARCP conditions are met for the RSO and the CRR to the network node. In some embodiments, the first set of operational tasks includes performing or continuing to perform measurements during the RSO even if the RSO is adjusted or receiving or monitoring one or more channels during the CRR. In some embodiments, the second set of operational tasks includes: (i) not performing or not continuing to perform measurements during the RSO, (ii) receiving or monitoring one or more channels during the CRR, (iii) stop adjusting the RSO or postponing the adjustment of the RSO for a certain time period, (iv) prioritizing reception of channels during the CRR over performing measurements during the adjusted RSO or vice versa depending on the type of CRR, (v) prioritizing performing measurements during the RSO over reception of paging during the CRR, (vi) refraining from receiving or monitoring a certain channel in up to G1 number of channel reception resources out of Gt number of consecutive channel reception resources, (vii) refraining from receiving or monitoring a certain channel in up to G1 number of channel reception resources during a certain time period, (viii) adapting one or more measurement requirements, (ix) extending a measurement time of measurements which the UE cannot perform in one or more adjusted RSOs, or (x) any combination of two or more of the tasks (i)-(ix). In some embodiments, the receiving or monitoring the one or more channels during the CRR includes receiving paging or receiving System Information (SI).

In some embodiments, the UE obtains the first set of operational tasks or the second set of operational tasks based on one or more rules. In some embodiments, the one or more rules include: (i) the UE receives paging even if an adjusted or shifted RSO is within Z1 time resources before a paging occasion or within Z2 time resources after the paging occasion, (ii) the UE receives paging even if the adjusted or shifted RSO partially or fully overlaps with the paging occasion, (iii) the UE receives System Information (SI) even if the adjusted or shifted RSO is within Z3 time resources before an SI reception occasion or within Z4 time resources after the SI reception occasion, or (iv) the UE receives the SI even if the adjusted or shifted RSO is partially or fully overlapping with the SI reception occasion. In some embodiments, the adjusted or shifted RSO includes a Synchronization Signal Block (SBB) Measurement Timing Configuration (SMTC) occasion. In some embodiments, the SI includes a Master Information Block (MIB), System Information Block 1 (SIB1), or other System Information Block (SIB).

In some embodiments, the wireless access network is a Non-Terrestrial Network (NTN).

Corresponding embodiments of a UE are also disclosed. In some embodiments, a UE includes transmitter circuitry and processing circuitry associated with the transmitter circuitry. The processing circuitry is configured to cause the UE to determine whether the UE meets one or more ARCP conditions for an RSO and a CRR. The processing circuitry is further configured to perform one or more operational tasks based on whether the UE meets the one or more ARCP conditions for the RSO and the CRR. In some embodiments, the performing the one or more operational tasks includes adapting at least one measurement scaling factor to a measurement time to extend the measurement time.

In some other embodiments, a non-transitory computer readable medium having code stored thereon, the code, when executed, causing a processor to perform a method as disclosed herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example architecture of a satellite network with bent pipe transponders.

FIG. 2 is a timing diagram showing an example of a Synchronization Signal Block (SSB), an SSB Measurement Time Configuration (SMTC) window, and a measurement gap.

FIG. 3 is an example timing diagram showing times when a User Equipment (UE) in an idle/inactive mode will wake-up for Automatic Gain Control (AGC) retuning, monitor paging occasions, perform intra-frequency measurements, and perform inter-frequency measurements.

FIG. 4 shows an example of a wireless communication system in which embodiments of the present disclosure may be implemented.

FIG. 5 is a timing diagram showing an example of multiple SMTC configurations per Measurement Object (MO) or per frequency layer that are transmitted/configured by a network in a cell.

FIG. 6 is a timing diagram showing an example of a reference scenario where a UE is configured with a Reference Signal (RS) configuration (e.g., a SMTC configuration) comprising periodic RS occasions and at least one set of periodic Channel Reception Resources (CRRs).

FIG. 7 is a timing diagram showing an example RS configuration (e.g., SMTC configuration) including a periodic RS occasion and periodically configured channel reception resources.

FIG. 8 is a timing diagram showing an example RS configuration (e.g., SMTC configuration) comprising a periodic RS occasion and periodically configured channel reception resources (e.g., paging occasion).

FIG. 9 shows an example of a process performed by a UE, in accordance with some example embodiments.

FIG. 10 shows a timing diagram illustrating Paging Occasion (PO) monitoring, AGC measurement and PO Time Division Multiplexed (TDM) with respect to SSB.

FIG. 11 shows another timing diagram illustrating PO monitoring, AGC measurement and PO TDM with respect to SSB.

FIG. 12 shows a timing diagram illustrating PO monitoring, AGC measurement and PO Frequency Division Multiplexed (FDM) with respect to SSB.

FIG. 13 shows an example of a communication system, in accordance with some embodiments.

FIG. 14 shows a UE, in accordance with some embodiments.

FIG. 15 shows a network node, in accordance with some embodiments.

FIG. 16 shows a block diagram of a host, in accordance with some embodiments.

FIG. 17 shows a block diagram illustrating a virtualization environment, in accordance with some embodiments.

FIG. 18 shows a communication diagram of a host communicating via a network node to a UE over a partially wireless connections, in accordance with some embodiments.

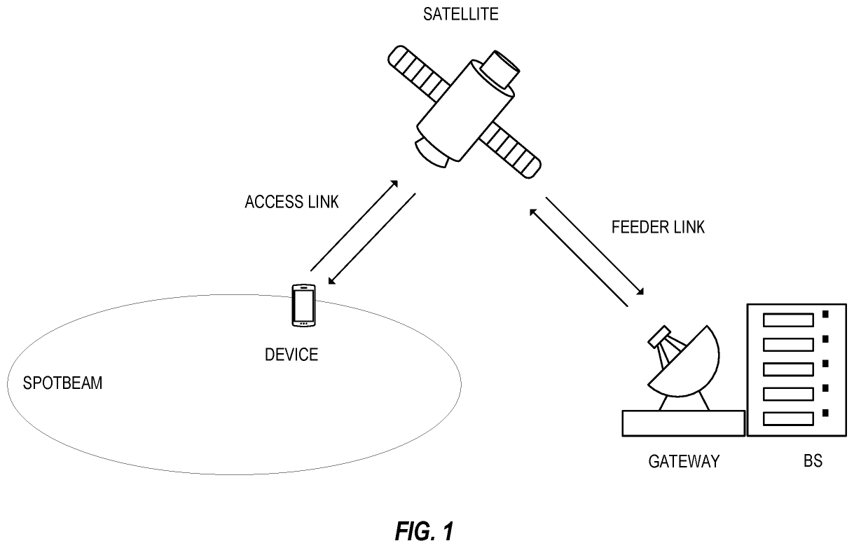

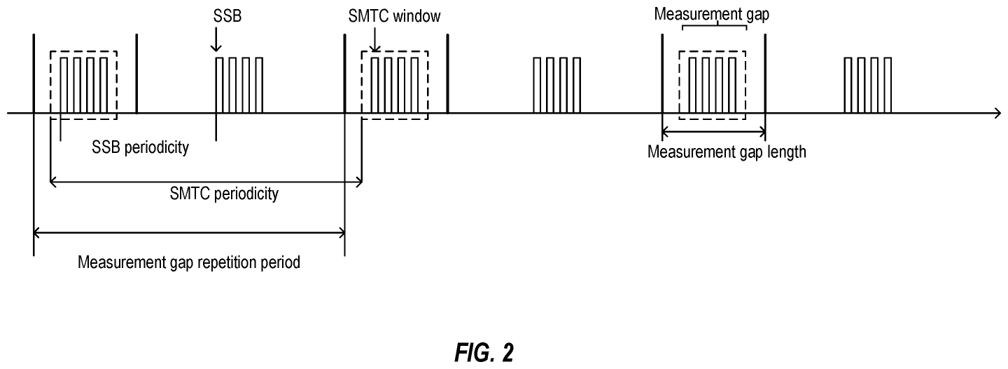

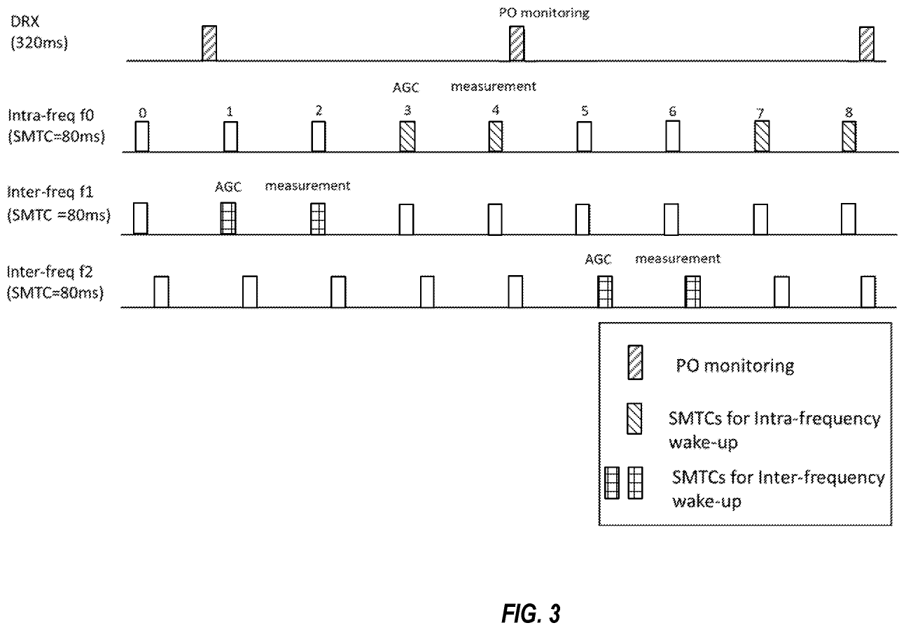

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In the present disclosure, the term “satellite” is often used even when a more appropriate term would be “network node (e.g., gNB) associated with the satellite”. The term “satellite” may also be called as a satellite node, a Non-Terrestrial Network (NTN) node, node in space, etc. Here, a network node (e.g., gNB) associated with a satellite might include both a regenerative satellite, where the network node is the satellite payload, i.e. the network node is integrated with the satellite, or a transparent satellite, where the satellite payload is a relay and network node is on the ground (i.e. the satellite relays the communication between the network node on the ground and the User Equipment (UE)).

A time period or duration over which a UE can maintain connection, or can camp on, or can maintain communication, and so on to a satellite or a network node (e.g., gNB) by UE is referred to as term “coverage time” or “serving time” or “network availability” or “sojourn time” or “dwell time” etc. The term “non-coverage time”, also known as “non-serving time” or “network unavailability”, or “non-sojourn time” or “non-dwell time” refers to a period of time during which a satellite or network node cannot serve or communicate or provide coverage to a UE. Another way to interpret the availability is not about a satellite/network being strictly unable to serve the UE due to lack of coverage but that the UE does not need to measure certain “not likely to be serving cell (satellite via which serving cell is broadcasted)”. In this case, the terminology may still be as in the no coverage case or it may be different, e.g. “no need to measure”.

The term node is used which can be a network node or a UE. Examples of network nodes include a Node B, base station (BS), multi-standard radio (MSR) radio node such as MSR BS, eNodeB (eNB), gNodeB (gNB), MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME, etc.), O&M, OSS, SON, positioning node (e.g. E-SMLC), etc.

The non-limiting term “UE” refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT, e.g. UTRA, E-UTRA, narrow band internet of things (NB-IoT), WiFi, Bluetooth, next generation RAT, New Radio (NR), 4G, 5G, NR NTN, IoT NTN, LTE NTN, etc. Any of the equipment denoted by the term node, network node or radio network node may be capable of supporting a single or multiple RATs.

Embodiments are described using generic terms of downlink (DL) reception or DL signal reception and uplink (UL) transmission or UL signal transmission. DL reception can include reception of one or more DL signals. Examples of DL signals are physical DL channels and DL physical signals. The physical channel (DL or UL) may carry higher layer information, e.g. control, data etc. Examples of DL physical channels are PDSCH, Physical Downlink Control Channel (PDCCH), Physical Broadcast Channel (PBCH), Control Resource Set (CORSET) etc. Examples of physical signals (DL or UL) are reference signals (may also be called as pilot signals, training sequence etc.). Examples of DL RS are PSS, SSS, SSB, CSI-RS, PRS, TRS, DMRS, reference signals (e.g., Primary Synchronization Signal (PSS), Secondary Synchronization Signal (SSS), Demodulation Reference Signal (DMRS) within SSB etc. Similarly, UL transmission can include physical UL channels or signals. Examples of UL physical channels are Physical Uplink Shared Channel (PUSCH), Physical Uplink Control Channel (PUCCH), SR, etc. Examples of UL RS are DMRS, Sounding Reference Signal (SRS), etc. When DL reception or UL transmission is described as being dynamically scheduled or semi-statically configured, it can therefore cover all the mentioned physical channels and signals.

The term “signal” or “radio signal” used herein can be any physical signal or physical channel. Examples of DL physical signals are reference signal (RS) such as PSS, SSS, Channel State Information Reference Signals (CSI-RS), DMRS signals in SS/PBCH block (SSB), discovery reference signal (DRS), CRS, PRS etc. RS may be periodic, e.g. RS occasion carrying one or more RSs may occur with certain periodicity, e.g. 20 ms, 40 ms, etc. The RS may also be aperiodic. Each SSB carries NR-PSS, NR-SSS and NR-PBCH in 4 successive symbols. One or multiple SSBs are transmit in one SSB burst which is repeated with certain periodicity, e.g. 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's System Frame Number (SFN)) etc. Therefore, SMTC occasion may also occur with certain periodicity, e.g. 5 ms, 10 ms, 20 ms, 40 ms, 80 ms, and 160 ms. Examples of UL physical signals are reference signal such as SRS, DMRS etc. The term physical channel refers to any channel carrying higher layer information, e.g. data, control, etc.

The term “time resource” used herein may correspond to any type of physical resource or radio resource expressed in terms of length of time. Examples of time resources are: symbol, sub-slot, mini-slot, time slot, subframe, radio frame, Transmission Time Interval (TTI), interleaving time, frame, SFN cycle, hyper-SFN (H-SFN) cycle, etc.

Some challenges that need to be addressed in Non-Terrestrial Networks (NTNs) include moving satellites resulting in moving cells or switching cells, and long propagation delays. These challenges are further detailed below.

Moving Satellites resulting in moving or switching cells: The default assumption in terrestrial network design, e.g. New Radio (NR) or Long Term Evolution (LTE), is that cells are stationary. This is not the case in NTN, especially when Low Earth Orbit (LEO) satellites are considered. A LEO satellite may be visible to a UE on the ground only for a few seconds or minutes. There are two different options for LEO deployment. The beam/cell coverage is fixed with respect to a geographical location with earth-fixed beams, i.e. steerable beams at the satellites ensure where a certain beam covers the same geographical area even as the satellite moves in relation to the surface of the earth. On the other hand, with moving beams, a LEO satellite has fixed antenna pointing direction in relation to the earth's surface, e.g. perpendicular to the earth's surface, and thus cell/beam coverage sweeps the earth as the satellite moves. In that case, the spotbeam, which is serving the UE, may switch every few seconds.

Long Propagation Delays: The propagation delays in terrestrial mobile systems are usually less than 1 millisecond. In contrast, the propagation delays in NTN can be much longer, ranging from several milliseconds (LEO) to hundreds of milliseconds (Geostationary Earth Orbit (GEO)) depending on the altitudes of the spaceborne or airborne platforms deployed in the NTN.

In Terrestrial Networks (TNs), the relative location in time of a Synchronization Signal Block (SSB) between a serving cell and a neighbor cell is fixed. The propagation delay within each cell depends on the cell size and UE location, and from UE's perspective it will only vary due to UE movement.

On the contrary, in an NTN for LEO scenarios, even the propagation delay between UE and serving cell will vary over time due to the movement of the satellite. Furthermore, the propagation delays towards neighbor cells on neighboring satellites will also change over time. The scenario may become worse when also accounting for feeder link delay and will increase with increasing satellite altitude.

The maximum SSB Measurement Time Configuration (SMTC) window duration is 5 subframes, and thus a statically configured window may not be able to handle the variation in propagation delays in an NTN. Since Radio Layer 2 (RAN2) has agreed that UEs are not required to monitor for SSBs outside the configured SMTC window, it makes measurements on neighbor cells in an NTN challenging with current SMTC configuration options, at least for (semi-) static SMTC configurations.

Moreover, different satellites are not necessarily time-synchronized in the sense that they use the same timing, are frame-synchronized, and transmit their SSB at the same location in the frame, unlike neighboring cells from the same satellite, which can be easily synchronized. Therefore, configuration of SMTC and measurement gaps as part of the SSB search and overall synchronization procedure should at least also consider this case and the potential time offset between satellites. The resulting time offset in SSB transmission between different cells needs to be considered as well for the SMTC window and gap configuration towards the UE.

Below are issues and agreements on SMTC in RAN2 meetings:
RAN2 #113bis and RAN2 #115 agreed that the maximum number of SMTC in one measurement object is 4. It was also agreed that the multiple SMTC configurations are enabled by introducing different new offsets in addition to the legacy SMTC configuration.

Agreements—Via Email (from Offline [106] @113Bis)
The multiple SMTC configurations are enabled by introducing different new offsets in addition to the legacy SMTC configuration. FFS how the offsets will be managed/signalled.
   Agreements Via Email—from Offline 112@115:
1. The specific maximum number of SMTC configuration in one measurement object with the same ssbFrequency can be 4. And a LS will be sent to RAN4 to confirm the conclusion.
In RAN2 #116-e, it was agreed that UE-based solution for SMTC adjustments in NTN is supported for IDLE/INACTIVE UEs. How the UE performs the necessary shifts in SMTC is for future study.
In RAN2 #116bis-e, the shift in SMTC was discussed and almost agreed.
Proposal 18: (16/20) Regarding UE-based solution for SMTC adjustments, UE autonomously adjust the SMTCs based on location and ephemeris.

The interpretation can be generalized as: a network node transmits information about at least two SMTC configurations per measurement object (e.g., per carrier frequency and/or for a group of cells) to one or more UEs in a cell. The UE determines and adjusts one or more SMTC configurations received in the cell (e.g., in serving cell), e.g. offset of SMTC, based on one or more criteria, and performs one or more operational tasks, e.g. performing one or more measurements on one or more cells etc.

However, the impact of a UE autonomously applying a SMTC shift on the operation of other signals is not defined. This may degrade the overall performance of UE operation in the NTN network. Solutions to this problem are disclosed herein.

Certain aspects of the disclosure and their embodiments may provide solutions to the aforementioned problems and/or other challenges. The embodiments are applicable to a scenario in which a UE is configured to perform one or more measurements on a Reference Signal (RS) (e.g., SSB) transmitted by one or more cells which are served or managed by their respective satellite nodes (also referred to herein as NTN nodes). The time-frequency resources containing the RS is determined by a RS configuration, e.g. SMTC configuration. The UE is configured by a network node (e.g., base station such as, e.g., gNB) with information for enabling the UE to identify the RS configuration. The satellite node may move with respect to the UE location over time. Therefore, to perform or continue performing the measurements on the RS, the UE is further configured to autonomously adjust or modify at least one parameter related to the RS configuration. Examples of the adjustment of the parameter related to the RS configuration are shifting the RS occasion or window (e.g., SMTC occasion or window) in time by certain margin (e.g., by applying a time offset larger than the configured time offset value, etc.), changing the duration of the RS occasion or window (e.g., SMTC occasion or window), or the like.

According to an embodiment, the UE determines whether the UE meets at least one Adjusted RS occasion-Channel reception resource Proximity (ARCP) condition and performs one or more operational tasks, which depend on whether the UE meets at least one ARCP condition. The operational task(s) may further depend on a type of adjusted RS and/or on a type of channel which is received or expected to be received by the UE. In one embodiment, the ARCP condition defines a timing relation between a timing of the adjusted RS occasion and a timing of channel reception resource. In one example, the UE meets at least one ARCP condition if the adjusted RS occasion and the channel reception resource at least partially overlap in time. In another example, the UE meets at least one ARCP condition even if the adjusted RS occasion and the channel reception resource are close in time (e.g., within certain time margin) but do not overlap in time. Examples of channel reception resources are Paging Reception Resource (PRR) (e.g., paging monitoring occasion, etc.), broadcast channel resource (e.g., physical channel (e.g., Physical Broadcast Channel (PBCH)) transmitting Master Information Block (MIB), physical channel (e.g., Physical Downlink Shared Channel (PDSCH)) transmitting one or more System Information Blocks (SIBs), etc.) etc. Examples of operational tasks are:
In one example of the operational task(s), if at least one ARCP condition is met, then the UE does not perform measurement during the adjusted RS occasion and instead receives the channel in the channel reception resource (e.g., receive paging). In this case the UE may further adapt the measurement procedure, e.g. extend the measurement time when the UE does not perform the measurement in the RS occasion. For example, the UE may adapt at least one measurement scaling factor or applying a new measurement scaling factor to the measurement time to extend the measurement time.
In another example of the operational tasks, if no ARCP condition is met then the UE may perform measurement during the adjusted RS occasion. In this case the UE may also receive the channel in the channel reception resource.

Some embodiments of the present disclosure relate to a set of mechanisms and procedures for the UE in an NTN to perform measurements with, e.g., SMTC configuration.

Certain embodiments may provide one or more of the following technical advantage(s) including enhancements in terms of the trade-off between flexibility and as well as explicit details and methods for realization of particular configurations.

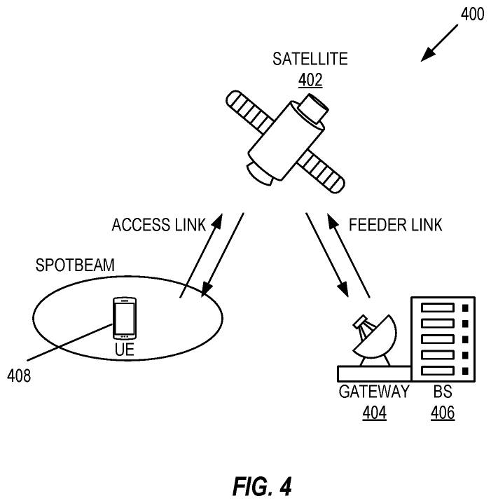

FIG. 4 illustrates one example of a wireless communication system 400 in which embodiments of the present disclosure may be implemented. As illustrated, the wireless communication system 400 includes an NTN or satellite-based radio access network (e.g., a 3GPP NR NTN), which includes a satellite 402 (which may alternatively be referred to herein as, e.g., an NTN node) and one or more gateways 404 that interconnect the satellite 402 to a land-based base station 406. In this example, a UE 408 communicates with the satellite radio access network via the satellite 402. Note that the wireless communication system 400 is only one example of a wireless communication system that utilizes an NTN for radio access. The embodiments disclosed here are equally applicable to any such system.

Embodiments of the present disclosure may relate to the following scenario. The scenario comprises a UE (e.g., the UE 408) configured to perform one or more measurements on a reference signal (RS) transmitted by one or more cells operated or managed by a network node, e.g. a satellite node (e.g., satellite 402). The UE may further be configured to be in low activity RRC state. Examples of low activity RRC state are RRC idle state, RRC inactive state, etc. To assist the UE in performing measurements, the UE is configured by the network node with information related to a RS configuration, e.g. via RRC signaling. The RS configuration information may be part of a Measurement Object (MO). In general, the RS configuration includes one or more parameters, e.g. RS index or identifier (e.g., RS1), RS duration or occasion or window, RS periodicity and time offset, etc. Examples of RS are SSB, CSI-RS, etc. Examples of RS configuration are SMTC configuration, CSI-RS configuration, etc. Each SMTC configuration transmitted to the UE in a MO is associated with corresponding SMTC parameters, e.g. SMTC index or identifier (e.g., SMTC1), SMTC duration, SMTC periodicity and time offset etc. Where, SMTC1, SMTC2, SMTC3 and SMTC4 indicate indexes or identifiers of multi-SMTC configured by network, they can also be referred to as RRC IE parameters.

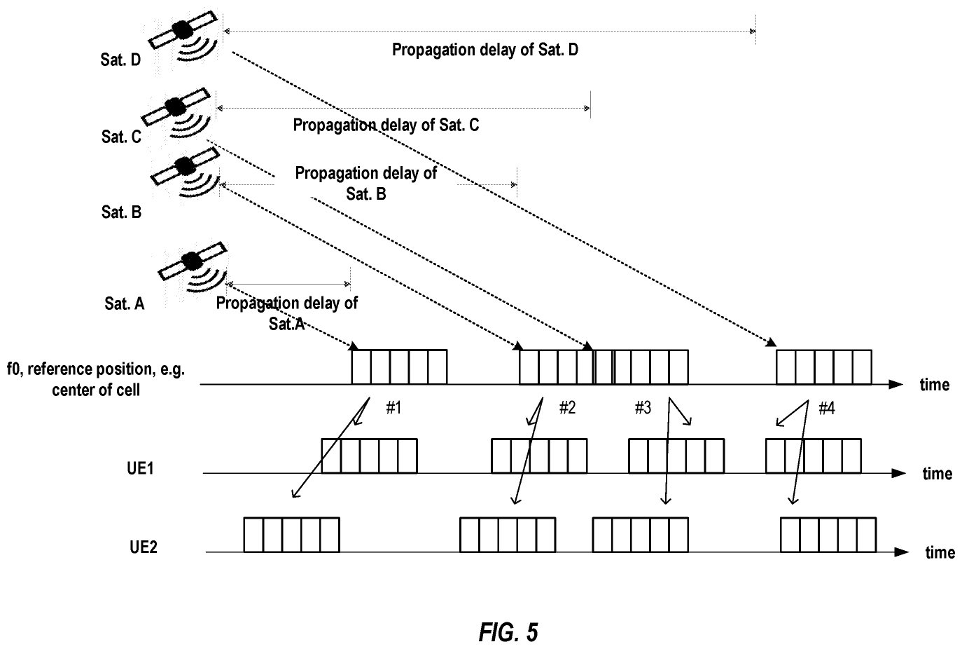

One example is depicted in FIG. 5, where 4 SMTC configurations per MO (measurement object) or per frequency layer are transmitted/configured by network1 in a cell (e.g., cell1). Under the situation that the timing of the SMTCs is not specially defined for a dedicated UE, e.g. in RRC_IDLE state, the UE needs to adjust SMTC autonomously with optional support of network assistance information. This implies that the actual timing of SMTC windows by different UEs are not necessarily the same. The example in FIG. 5 shows two UEs, UE1 and UE2, having different timing of SMTC windows after determination at the UE-side even though they are signaled the same SMTC configurations by the network.

In embodiments of the present disclosure, the UE 408 does not drop any paging and/or system information due to SSB-based measurements when either paging occasion (PO) is TDM or FDM with respect the SSB location when the UE 408 determines more than one SMTC. The Radio Resource Management (RRM) measurement requirements in RRC idle/inactive states may be impacted due to paging reception depending on at least the following parameters: DRX cycle length and/or SMTC period.

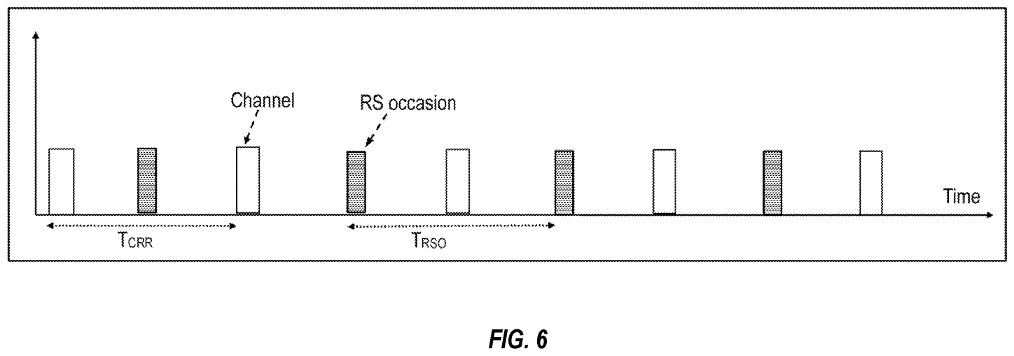

FIG. 6 shows an example of a reference scenario in which the UE 408 is configured with a RS configuration (e.g., a SMTC configuration) comprising periodic RS occasions and at least one set of periodic channel reception resources (CRRs) with periodicity of TCRR. The RS configuration comprises also a set of periodic RS occasions (e.g., paging occasions) with periodicity of TRSO. In the reference scenario, the UE 408 does not adjust or shift or modify any parameter of the configured RS configuration.

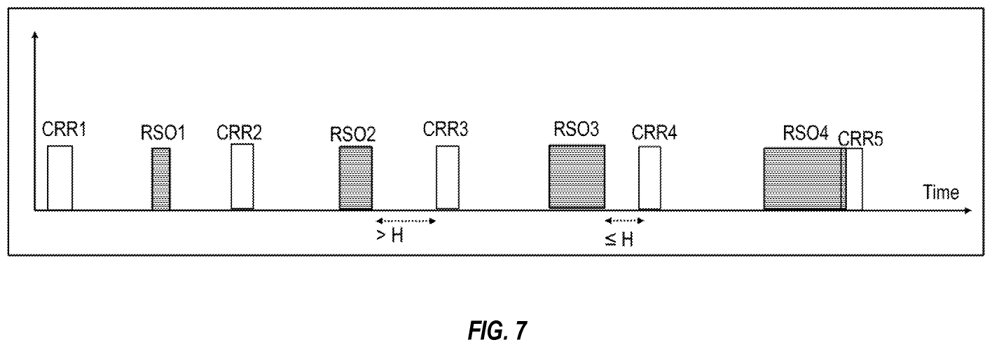

FIG. 7 shows an example RS configuration (e.g., SMTC configuration) comprising a periodic RS occasion and periodically configured channel reception resources (e.g., paging occasion) with adjustment of few RS occasions. The adjustment comprises extending the RSO duration. In other words, FIG. 7 shows another exemplary scenario in which the UE 408 autonomously adjusts or shifts or modifies at least one parameter (e.g., RS occasion (RSO)) of the configured RS configuration (e.g., SMTC configuration). More specifically, the UE 408 adjusts or shifts RSO2, RSO3, and RSO4 in time. In this example, the adjustment of RSO comprises extending the duration of the RSO, e.g. from 5 ms to 8 ms etc. In this example, the starting time of the RSO is the same as configured by the network node. Therefore, the duration of the RSO is also extended compared to the duration of the RSO configured by the network. The following observations are made:
1. The magnitude of the difference between the end of RSO2 in time and the start of CRR3 in time is larger than certain threshold (H).
2. The magnitude of the difference between the end of RSO3 in time and the start of CRR4 in time is less than H.
3. RSO4 and the start of CRR5 at least partially overlap in time.

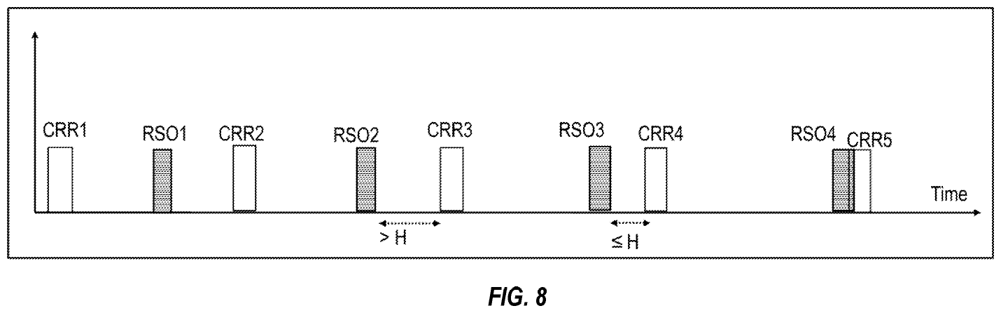

FIG. 8 shows an example showing a RS configuration (e.g., SMTC configuration) comprising a periodic RS occasion and periodically configured channel reception resources (e.g., paging occasion) with adjustment of few RS occasions. The adjustment comprises shifting the RSO in time. In other words, FIG. 8 shows yet another exemplary scenario in which the UE 408 autonomously adjusts or shifts or modifies at least one parameter (e.g., RS occasion (RSO)) of the configured RS configuration. More specifically, the UE 408 also adjusts or shifts RSO2, RSO3, and RSO4 in time. However, in this example, the adjustment of RSO comprises only shifting RSO in time with respect to a reference time (Tr), e.g. by 3 ms with respect to Tr. In one example Tr can be expressed in terms of an absolute time such as universal clock (e.g., UTC). In another example, Tr can be expressed in terms of a time resource number or a counter, e.g. subframe number, slot number, system frame number (SFN), hyper-SFN, etc. For example, how much the RSO is shifted compared to Tr comprising SFN #X1 and subframe number #X2. Examples of X1 and X2 are 0 and 0 respectively, or 16 and 1 respectively. In another example, Tr can be the starting time of the RSO configured by the network node. In another example, Tr can be the ending time of the RSO configured by the network node. In another example, Tr can be the center of the RSO in time configured by the network node. In this example, the starting time of the adjusted RSO is shifted by certain margin (e.g., Y1 time resources) with respect to Tr. In another example, Tr can be the starting time of the RSO before the RSO is shifted in time or the starting time of the RSO before applying the last or the recent shift to the RSO time. Therefore, the duration of the RSO is the same as configured by the network. The following observations are made:
1. The magnitude of the difference between the end of RSO2 in time and the start of CRR3 in time is larger than certain threshold (H).
2. The magnitude of the difference between the end of RSO3 in time and the start of CRR4 in time is less than H.
3. RSO4 and the start of CRR5 at least partially overlap in time.

The embodiments described herein are applicable to both scenarios illustrated in FIGS. 7 and 8.

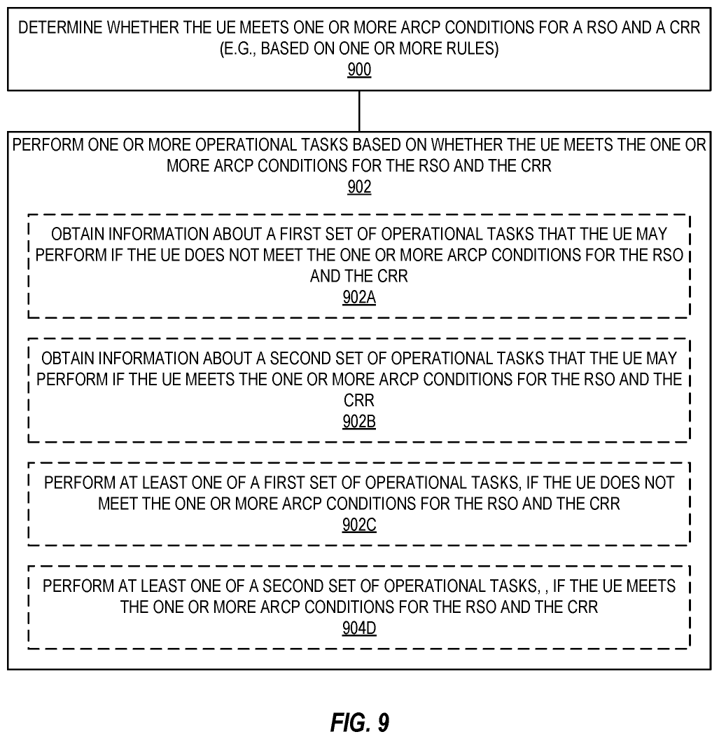

FIG. 9 illustrates the operation of the UE 408 in accordance with at least some of the embodiments described herein. As illustrated, the UE 408 determines whether the UE 408 meets one or more adjusted RS occasion-channel reception resource reception (ARCP) conditions for an RS occasion (RSO) and a channel reception resource (CRR) (also referred to herein as a set of a RSO and CRR or a set consisting of one RSO and one CRR or a RSO and CRR pair) (step 900). This determination is made based on one or more rules. Based on the above observations with respect to FIGS. 7 and 8, one or more rules for determining whether the UE 408 meets the ARCP condition(s) for the RSO and the CRR can include any one or more of the following rules:
The UE 408 meets the ARCP condition for a certain set of RSO and CRR provided that at least one of the following conditions or criteria are met; otherwise, the UE 408 does not meet the ARCP condition:
   1. If the RS occasion (RSO) and at least one channel reception resource (CRR) at least partially overlap in time with respect to each other.
   2. If the RSO and at least one CRR are close to each other in time even if they do not overlap in time with respect to each other. They are considered to be close in time provided that at least one of the following conditions or criteria are met; otherwise, they are not considered to be close in time with respect to each other:
      a) If the distance in time between RSO and the CRR is within certain threshold (H1).
      b) If the distance in time between RSO and the CRR is not larger than certain threshold (H2).
      c) If the magnitude of the difference between the timing of RSO and the timing of CRR is less than or equal to certain threshold (H3). Specific examples of this condition are:
         I. If the magnitude of the difference between the end of RSO in time and the start of CRR in time is less than or equal to certain threshold (H31).
         II. If the magnitude of the difference between the start of RSO in time and the start of CRR in time is less than or equal to certain threshold (H32).
         III. If the magnitude of the difference between the start of RSO in time and the end of CRR in time is less than or equal to certain threshold (H33).
         IV. If the magnitude of the difference between the end of CRR in time and the start of RSO in time is less than or equal to certain threshold (H34).
         V. If the magnitude of the difference between the start of CRR in time and the start of RSO in time is less than or equal to certain threshold (H35).
         VI. If the magnitude of the difference between the start of CRR in time and the end of RSO in time is less than or equal to certain threshold (H36).
            Thresholds, H1, H2, H3, H31, H32, H33, H34, H35 and H36 may be pre-defined or configured by the network node. Examples of thresholds are 80 ms, 160 ms, longest RSO periodicity etc.

The UE 408 performs one or more operational tasks based on whether the UE 408 meets the ARCP condition for certain set of RSO and CRR (step 902). In some example embodiments, the one or more operational tasks include adapting at least one measurement scaling factor to a measurement time to extend the measurement time. In one embodiment, the UE 408 obtains:
Information about a first set of operational tasks which the UE 408 may perform if the UE 408 does not meet the ARCP condition for a set of RSO and CRR (step 902A), and
Information about a second set of operational tasks which the UE 408 may perform if the UE meets the ARCP condition for a set of RSO and CRR (step 902B).

The UE 408 may obtain the information about the first set of operational tasks and/or the information about the second set of operational tasks based on one or more rules. The rules may be pre-defined and/or configured by a network node, e.g. by serving network node of the UE.

Examples of the first set of operational tasks are:
1. In one example, if the UE 408 does not meet the ARCP condition for a set of an RSO and a CRR (i.e., a set consisting of one RSO and one CRR), then the UE 408 may perform or continue performing the measurements during the RSO in the set of the RSO and the CRR even if the RSO is adjusted. The UE 408 further receives or monitors one or more channels during that CRR, e.g. receive paging, receiving system information (e.g., MIB, SIB1, other SIBs etc.).

Examples of the second set of operational tasks are:
1. In one example, if the UE 408 meets the ARCP condition for a set of an RSO and a CRR, then the UE 408 does not perform or does not continue performing the measurements during the RSO in the set of the RSO and the CRR. The UE 408 however receives or monitors one or more channels during the CRR in the set of the RSO and the CRR, e.g. receive paging, receiving system information (e.g., MIB, SIB1, other SIBs, etc.). Therefore, the UE 408 prioritizes the reception of the channels during the CRR (e.g., paging reception during PO, SI acquisition during PBCH and/or PDSCH carrying SIBs) over performing measurements during the adjusted RSO.
2. In another example, if the UE 408 meets the ARCP condition for a set of RSO and a CRR, then the UE 408 may stop adjusting the RSO or postpone the adjustment of the RSO for certain time period. The UE 408 may also stop performing the measurement during the RSO. The UE 408 however may receive or monitor one or more channels during that CRR.
3. In another example, if the UE 408 meets the ARCP condition for a set of RSO and a CRR, then whether the UE 408 prioritizes the reception of the channels during the CRR over performing measurements during the adjusted RSO or vice versa depends on the type of CRR.
   In one example, the UE 408 prioritizes performing the measurement during RSO over the reception of SI during the CRR. In this example, this means the UE 408 does not receive the SI during the CRR, e.g. the UE may postpone the reception of the SI to a later CRR occurring in future. But in another example, the UE 408 prioritizes the reception of paging during the CRR over performing the measurement during the RSO. In this example, this means the UE 408 does not perform the measurement during the RSO, e.g. the UE 408 may postpone the measurements to a later RSO.
   In one example, the UE 408 prioritizes performing the measurement during RSO over the reception of paging during the CRR. But in another example, the UE 408 prioritizes the reception of SI during the CRR over performing the measurement during the RSO.
4. In another example, the UE 408 is allowed not to receive or monitor a certain channel up to G1 number of channel reception resources out of Gt number of consecutive channel reception resources due to meeting the ARCP condition. Where G1≤Gt. In one example G1=1. In another example G1>1.
5. In another example, the UE 408 is allowed not to receive or monitor certain channel in up to G1 number of channel reception resources during certain time period (T41) due to meeting the ARCP condition. In one example, G1=1. In another example, G1>1. In one example, T41 is L1 number of DRX cycles.
6. In any of the above examples, the UE 408 may adapt one or more measurement requirements associated with the measurement which is not performed by the UE 408 or which is not fully performed by the UE 408 during the RSO (due to meeting ARCP condition). Examples of measurement requirement requirements are measurement time, measurement accuracy etc. Examples of measurement time are measurement period, cell detection period, evaluation period, cell selection time etc. An example of adapting the measurement time may comprise extending the measurement time.
7. Specific examples of rules which can be defined are as follows:
   a) The UE 408 shall receive paging even if the adjusted or shifted RS occasion (e.g., SMTC occasion) is within Z1 time resources before the paging occasion or within Z2 time resources after the paging occasion. However, in this case, the UE 408 is allowed to extend the measurement time for one or more measurements. In one example, Z1=Z2. In another example, Z1+Z2. Examples of Z1 and Z2 are 160 ms.
   b) The UE 408 shall receive paging even if the adjusted or shifted RS occasion (e.g., SMTC occasion) partially or fully overlap with the paging occasion. However, in this case, the UE 408 is allowed to extend the measurement time for one or more measurements.
   c) The UE 408 shall receive system information (SI) (e.g., MIB, SIB1, other SIBs etc.) even if the adjusted or shifted RS occasion (e.g., SMTC occasion) is within Z3 time resources before the SI reception occasion or within Z4 time resources after the SI reception occasion. However, in this case, the UE 408 is allowed to extend the measurement time for one or more measurements. In one example, Z3=Z4. In another example, Z3+Z4. Examples of Z3 and Z4 are 160 ms.
   d) The UE 408 shall receive SI even if the adjusted or shifted RS occasion (e.g., SMTC occasion) partially or fully overlap with the SI reception occasion.
      However, in this case the UE 408 is allowed to extend the measurement time for one or more measurements.
8. Specific examples to illustrate a method in a UE 408 of extending the measurement time of the measurements which the UE 408 cannot perform measurements in one or more adjusted RSO are described below.

In regard to #8 above, the specific examples to illustrate the method in the UE 408 of extending the measurement time of the measurements in which the UE 408 cannot perform measurements in one or more adjusted RSO are as follows:

### Impact of TDM Between PO and SSB

In idle mode, for most cases, the paging occasion and the closest SMTC is less than SMTC-periodicity divided by two. If the closest SMTC window is close to the paging occasion, after the UE 408 performs intra-frequency measurement, amplitude gain control (AGC) adjustment, and fine timing during the SMTC duration, the UE 408 enters to idle state until the next paging occasion arrives. How close the SMTC occasion and PO depends on UE implementation. The time interval is less than tens of milliseconds.

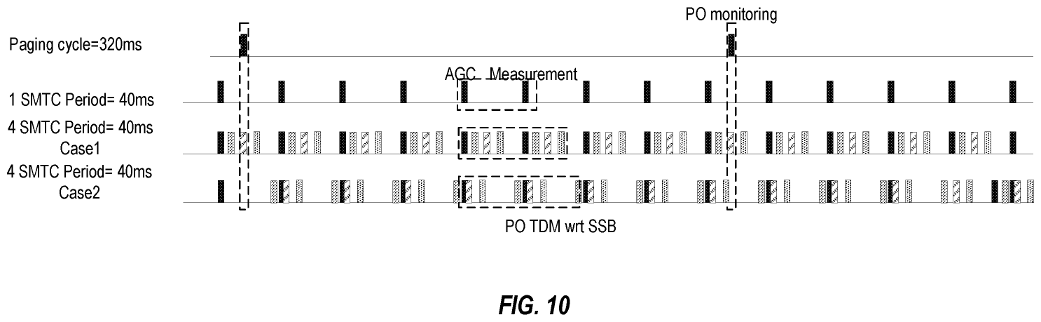

The worst case is that the paging cycle (i.e., DRX cycle) is in the middle of the SMTC periodicity as shown in FIG. 10 (1 SMTC, periodicity=40 ms, DRX=320 ms). FIG. 10 illustrates PO TDM with respect to SSB, DRX=320 ms. Considering the worst case and the SMTC periodicity >20 ms, the possible UE implementation is that the UE 408 performs intra-frequency measurement, AGC adjustment, and fine timing during the SMTC duration and then RF power down until the paging occasion arrives. If the closest SMTC occasion is far away from the paging occasion, UE 408 may need to wake up twice during one DRX.

A general scaling factor for relaxing the measurement to avoid the UE 408 waking up twice within the paging cycle is:
T_serving=f1(M1, fp1(TSMTC), fp2(DRX)), to represent Table 3.
Te_reselection=f2(M2, fp3(TSMTC), fp4(DRX)), to represent Table 4
   where, in present requirements:
T_serving is Nₛₑᵣᵥ,
Te_reselection is T_{detect,NR_Intra}, T_{measure,NR_Intra} and T_{evaluate,NR_Intra} for intra-frequency measurement, T_{detect,NR_Inter}, T_{measure,NR_Inter} and T_{evaluate,NR_Inter} for inter-frequency measurement.
M1=2, fp1(TSMTC): TSMTC>20 ms and fp2 (DRX): DRX cycle ≤0.64 s, for serving cell measurement.
M2=1.5, fp3(TSMTC): TSMTC>20 ms and fp4(DRX): DRX cycle <0.64 s, for intra-frequency and inter-frequency measurements.

In FIG. 10, as an example, increasing SMTC number to 4, there are some new issues exists:
In case1, all 4 SMTC windows are close together, when the serving cell SMTC is close to PO, same as present 1 SMTC case, the other 3 SMTC windows may collide with PO. More relaxation on measurement is needed to keep PO reception.
In case2, 3 SMTC windows are separated in distance from serving cell SMTC, part of total 4 SMTC windows may be out of reception window for AGC and measurement, and extra measurement time is needed to adjust receiving window to cover proper AGC and measurement.
In case2, the fact a SSB is used for AGC before measurement shall be valid in multi-SMTC configuration, but multi-SMTC may cause last SSB for AGC is very close to next SSB for measurement and radio circuit can't complete retuning in so short time.

One example is when offsets of SMTC windows are shifting, e.g. changing from case1 to case2, reception window needs to be updated accordingly. During processing time, measurements may be invalid and longer measurement time is needed.

The above issues need extra scaling factor or extending current scaling factor for measurements to avoid the UE 408 waking up more than twice within the paging cycle, including serving cell measurement, intra-frequency, and inter-frequency measurements.

In one example, Updated scaling factor replace M1, M2:
T_serving=f1(M3, fp1(TSMTC), fp2(DRX)).
Te_reselection=f2(M4, fp3(TSMTC), fp4(DRX)).
Where, M3 is different from M1, e.g. 3, 4 . . . ; M4 is different from M2, e.g. 2, 3 . . . .

In another example, the new scaling factor to be added to M1, M2:
T_serving=f1(M1*M5, fp1(TSMTC), fp2(DRX)).
Te_reselection=f2(M2*M6, fp3(TSMTC), fp4(DRX)).
Where, M3 is different from M1, e.g. 3, 4 . . . ; M4 is different from M2, e.g. 2, 3 . . . .

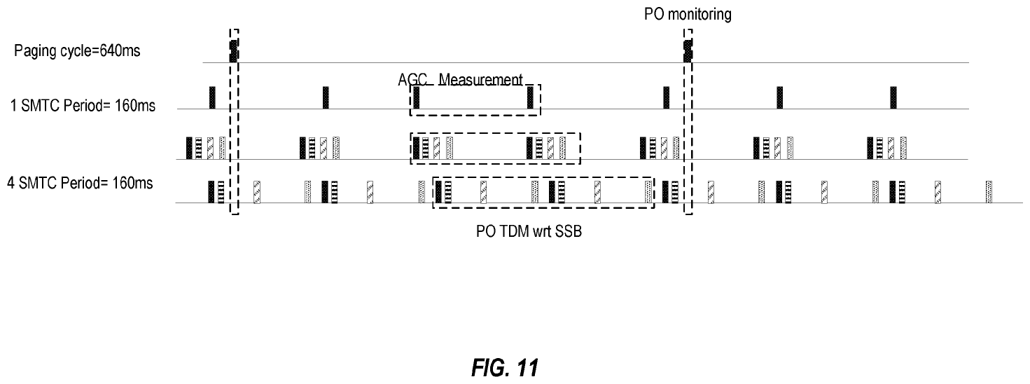

It should be noted that, in idle/inactive states, the DRX cycles that relaxation is applied on are 320 ms for serving cell and 320 ms/640 ms for intra-frequency and inter-frequency measurement. FIG. 11 illustrates PO TDM with respect to SSB, DRX=640 ms. FIG. 11 illustrates that multi-SMTC may cause longer ‘radio_on’ time with regard to longer DRX, e.g. DRX=640 ms, 1280 ms and so on, compared with present relaxation which only occurs on DRX 320 ms, which cause more power consumption on the UE 408.

To avoiding too higher power consumption, the relaxations on DRX are generalized:
T_serving=f1(M1, fp1(TSMTC), fp6(DRX))
Te_reselection=f2(M2, fp3(TSMTC), fp8(DRX))
In one example, fp5(TSMTC): TSMTC>40 ms and fp6(DRX): DRX cycle ≤1.28 s
In one example, fp3(TSMTC): TSMTC>40 ms and fp4(DRX): DRX cycle <1.28 s

Also, above relaxations on scaling factor and SMTC/DRX can be combined as follow:
T_serving=f1(M3, fp5(TSMTC), fp9(DRX)).
Te_reselection=f2(M4, fp7(TSMTC), fp10(DRX))

Or,
T_serving=f1(M1*M5, fp5(TSMTC), fp6(DRX)).
Te_reselection=f2(M2*M6, fp7(TSMTC), fp10(DRX))

### Impact of FDM Between PO and SSB

In case of FDM solution where PO will be configured in the SMTC occasions (i.e., in time resources containing SSB), the UE 408 cannot receive both SSB and PO simultaneously unless the UE 408 is capable of multiple numerologies. It is not appropriate to drop PO in the SMTC occasion, the UE 408 needs to always monitor paging during the POs.

If the subcarrier spacing (SCS) of PO CORESET is the same as SSB, the UE 408 can perform intra-frequency measurements and paging reception simultaneously. If the SCS of PO CORESET is the different with SSB SCS, how the UE 408 performs measurement depends on the UE capability. A UE that supports mix numerology can still perform intra-frequency measurements and paging reception simultaneously.

For a UE that does not support mix numerology, the paging reception shall be guaranteed, and the measurements shall be performed on the SMTC outside the paging occasion. From UE behavior point of view, whatever the SMTC periodicity is, the UE 408 always additionally wakes up once for intra-frequency measurement on top of paging reception shown in FIG. 10 (1SMTC, periodicity=40 ms, DRX=320 ms).

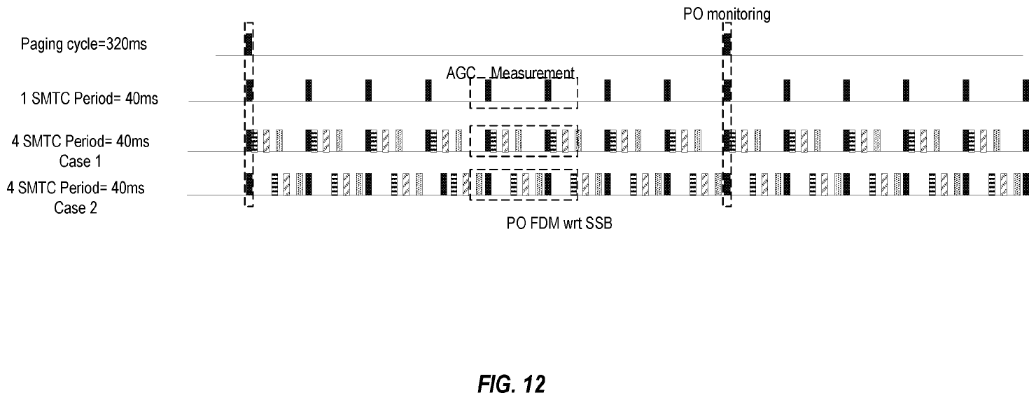

In FIG. 12, as an example, increasing SMTC number to 4, there are three issues exists:
In case1, all 4 SMTC windows are close together, not only the serving cell SMTC is aligned with PO, but more SMTC collides with PO also. More relaxation on measurement is needed to keep PO reception.
In case 2, 3 SMTC windows are separated in distance from serving cell SMTC, part of total 4 SMTC windows may be out of reception window for AGC and measurement, and extra measurement time is needed to adjust receiving window to cover proper AGC and measurement.
In case 2, the fact a SSB is used for AGC before measurement shall be valid in multi-SMTC configuration, but multi-SMTC may cause last SSB for AGC is very close to next SSB for measurement and radio circuit cannot complete retuning in so short time.

One example is when offsets of SMTC windows are shifting, e.g. changing from case1 to case2, reception window needs to be updated accordingly. During processing time, measurements may be invalid and longer measurement time is needed.

Same to the issues on TDM between PO and SSB, extension on scaling factor or new scaling factor is needed and criteria of SMTC and DRX is changed if necessary.

### Scaling Factor Between PO and SSB

There are some additional embodiments in terms of different conditions.

In one example, the scaling factor in the present disclosure depends on the shift distance or offset of SMTCs adjusted by the UE 408.
In one example, if the UE 408 adjusts SMTC windows with distance less than threshold (TH1) in time domain, relaxation in the present disclosure is invalid, if the UE 408 adjust SMTC windows with distance greater than threshold (TH1) in time domain, relaxation in the present disclosure is valid.
In another example, if the UE 408 adjusts SMTC windows with distance less than threshold (TH1) in time domain, relaxation in the present disclosure is valid, if UE adjust SMTC windows with distance greater than threshold (TH1) in time domain, relaxation in the present disclosure is invalid.

In another example, the scaling factor in the present disclosure depends on the number of SMTC windows adjusted by UE.
In one example, if the UE 408 adjusts 1 of 4 SMTC windows, relaxation in the present disclosure is invalid.
In another example, if the UE 408 adjusts all SMTC windows simultaneously, relaxation in the present disclosure is valid.

In another example, the scaling factor in the present disclosure depends on when SMTC windows are adjusted.
In one example, before the time passes by T1 after the UE 408 adjusts SMTCs, relaxation in the present disclosure is valid, after the time passes by T1 after UE adjusts SMTCs, relaxation in the present disclosure is invalid.
In another example, before the time passes by T1 after the UE 408 adjusts SMTCs, relaxation in the present disclosure is invalid, after the time passes by T1 after UE adjusts SMTCs, relaxation in the present disclosure is valid.

Another example is PO can be dropped when the UE 408 adjusts SMTCs, but PO shall not be dropped in a DRX in which no SMTC is shifted.

Another example is the range of SMTC adjustment shall be limited without impact to PO, e.g. the adjustment range of SMTC windows shall keep distance threshold (OH3) to PO.

Another example is some SMTCs can be skipped in order to ensure PO reception, but no measurement requirement is expected on the skipped SMTCs.

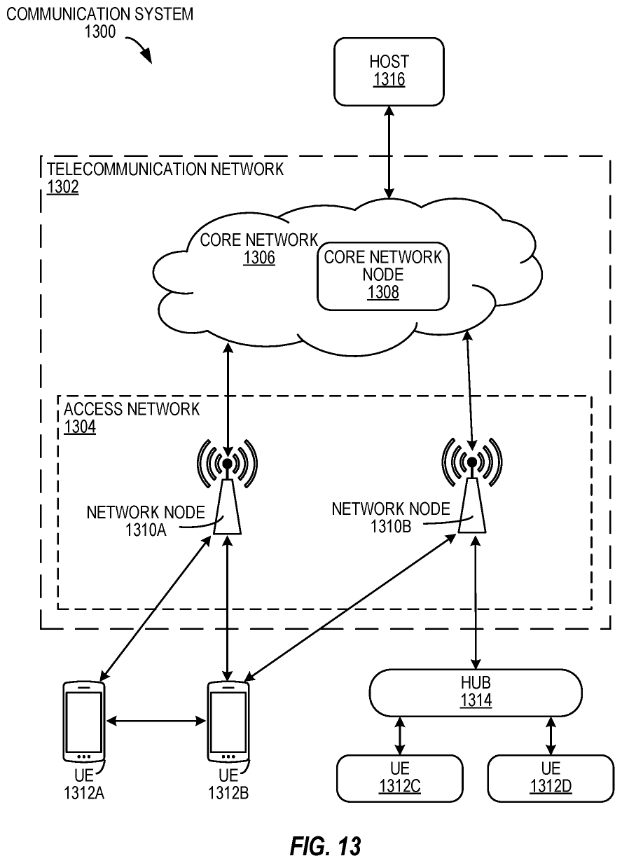

FIG. 13 shows an example of a communication system 1300 in accordance with some embodiments. In the example, the communication system 1300 includes a telecommunication network 1302 that includes an access network 1304, such as a Radio Access Network (RAN), and a core network 1306, which includes one or more core network nodes 1308. The access network 1304 includes one or more access network nodes, such as network nodes 1310A and 1310B (one or more of which may be generally referred to as network nodes 1310), or any other similar Third Generation Partnership Project (3GPP) access node or non-3GPP Access Point (AP). The network nodes 1310 facilitate direct or indirect connection of User Equipment (UE), such as by connecting UEs 1312A, 1312B, 1312C, and 1312D (one or more of which may be generally referred to as UEs 1312) to the core network 1306 over one or more wireless connections. Note that one or more of the network nodes 1310 may be base stations 406 (FIG. 4) having feeder link to the satellite 402 (FIG. 4) for an NTN. In some example embodiments, one or more of UEs 1312 perform the functions and features described above with respect to UE 408. In some example embodiments, one or more of network nodes 1310 perform the functions and features described above with respect to BS 406 and/or gateway 404.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system 1300 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1302 is a cellular network that implements 3GPP standardized features. Accordingly, the telecommunication network 1302 may support network slicing to provide different logical networks to different devices that are connected to the telecommunication network 1302. For example, the telecommunication network 1302 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1314 communicates with the access network 1304 to facilitate indirect communication between one or more UEs (e.g., UE 1312C and/or 1312D) and network nodes (e.g., network node 1310B). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a Virtual Reality (VR) headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310B. The hub 1314 may also allow for a different communication scheme and/or schedule between the hub 1314 and UEs (e.g., UE 1312C and/or 1312D), and between the hub 1314 and the core network 1306. In other examples, the hub 1314 is connected to the core network 1306 and/or one or more UEs via a wired connection. Moreover, the hub 1314 may be configured to connect to a Machine-to-Machine (M2M) service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310B. In other embodiments, the hub 1314 may be a non-dedicated hub—that is, a device which is capable of operating to route communications between the UEs and the network node 1310B, but which is additionally capable of operating as a communication start and/or end point for certain data channels.

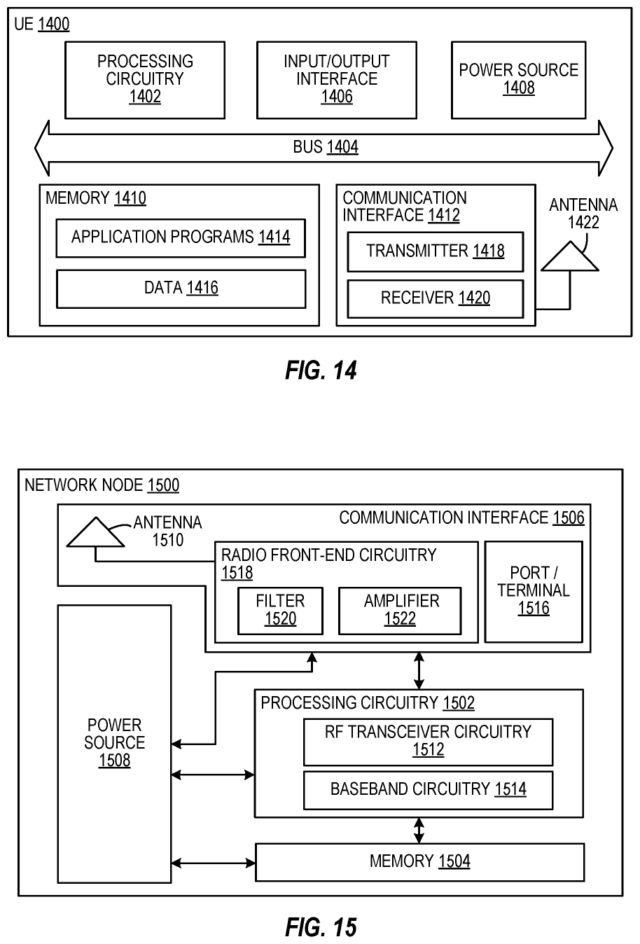

FIG. 14 shows a UE 1400 in accordance with some embodiments. As used herein, a UE refers to a device capable, configured, arranged, and/or operable to communicate wirelessly with network nodes and/or other UEs. In some example embodiments, UE 1400 performs the functions and features described above with respect to UE 408. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1402 may include multiple Central Processing Units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging the power source 1408. Power circuitry may perform any formatting, converting, or other modification to the power from the power source 1408 to make the power suitable for the respective components of the UE 1400 to which power is supplied.

The memory 1410 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1410 may allow the UE 1400 to access instructions, application programs, and the like stored on transitory or non-transitory memory media, to off-load data, or to upload data. An article of manufacture, such as one utilizing a communication system, may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., the antenna 1422) and may share circuit components, software, or firmware, or alternatively be implemented separately.

In the illustrated embodiment, communication functions of the communication interface 1412 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1412, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 15 shows a network node 1500 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)). In some example embodiments, network node 1500 performs the functions and features described above with respect to BS 406 and/or gateway 404. BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes processing circuitry 1502, memory 1504, a communication interface 1506, and a power source 1508. The network node 1500 may be composed of multiple physically separate components (e.g., a Node B component and an RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1500 may be configured to support multiple RATs. In such embodiments, some components may be duplicated (e.g., separate memory 1504 for different RATs) and some components may be reused (e.g., an antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1500.

The processing circuitry 1502 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1500 components, such as the memory 1504, to provide network node 1500 functionality.

In some embodiments, the processing circuitry 1502 includes a System on a Chip (SOC). In some embodiments, the processing circuitry 1502 includes one or more of Radio Frequency (RF) transceiver circuitry 1512 and baseband processing circuitry 1514. In some embodiments, the RF transceiver circuitry 1512 and the baseband processing circuitry 1514 may be on separate chips (or sets of chips), boards, or units, such as radio units and digital units. In alternative embodiments, part or all of the RF transceiver circuitry 1512 and the baseband processing circuitry 1514 may be on the same chip or set of chips, boards, or units.

The memory 1504 may comprise any form of volatile or non-volatile computer-readable storage medium including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and the memory 1504 are integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. The radio front-end circuitry 1518 comprises filters 1520 and amplifiers 1522. The radio front-end circuitry 1518 may be connected to the antenna 1510 and the processing circuitry 1502. The radio front-end circuitry 1518 may be configured to condition signals communicated between the antenna 1510 and the processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of the filters 1520 and/or the amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface 1506 may comprise different components and/or different combinations of components.

In certain alternative embodiments, the network node 1500 does not include separate radio front-end circuitry 1518; instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes the one or more ports or terminals 1516, the radio front-end circuitry 1518, and the RF transceiver circuitry 1512 as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, the communication interface 1506, and/or the processing circuitry 1502 may be configured to perform any receiving operations and/or certain obtaining operations described herein as being performed by the network node 1500. Any information, data, and/or signals may be received from a UE, another network node, and/or any other network equipment. Similarly, the antenna 1510, the communication interface 1506, and/or the processing circuitry 1502 may be configured to perform any transmitting operations described herein as being performed by the network node 1500. Any information, data, and/or signals may be transmitted to a UE, another network node, and/or any other network equipment.

The power source 1508 provides power to the various components of the network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid or an electricity outlet) via input circuitry or an interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

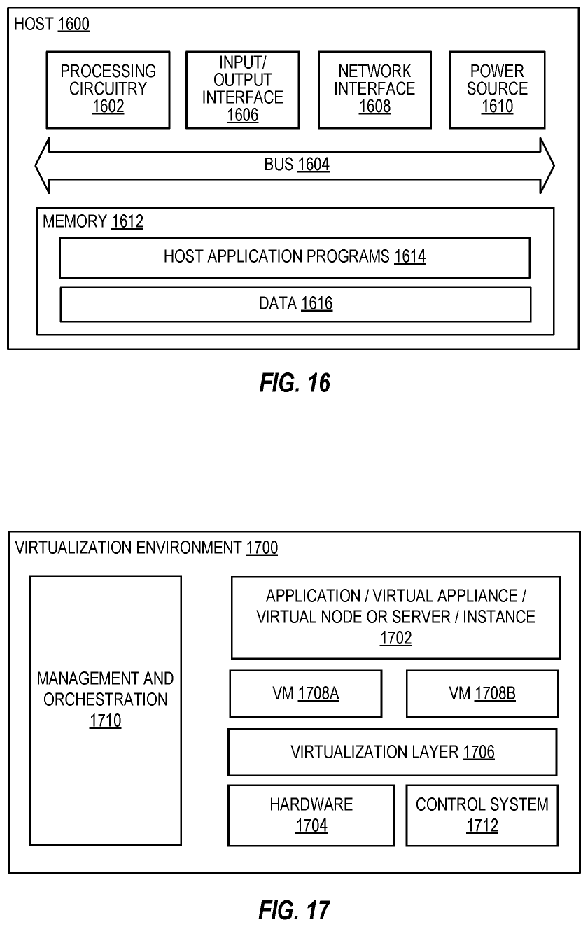

FIG. 16 is a block diagram of a host 1600, which may be an embodiment of the host 1316 of FIG. 13, in accordance with various aspects described herein. As used herein, the host 1600 may be or comprise various combinations of hardware and/or software including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and memory 1612. Other components may be included in other embodiments. Features of these components may be substantially similar to those described with respect to the devices of previous figures, such as FIGS. 14 and 15, such that the descriptions thereof are generally applicable to the corresponding components of the host 1600.

The memory 1612 may include one or more computer programs including one or more host application programs 1614 and data 1616, which may include user data, e.g. data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for Over-The-Top (OTT) services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or VM Monitors (VMMs)), provide VMs 1708A and 1708B (one or more of which may be generally referred to as VMs 1708), and/or perform any of the functions, features, and/or benefits described in relation with some embodiments described herein. The virtualization layer 1706 may present a virtual operating platform that appears like networking hardware to the VMs 1708.

The VMs 1708 comprise virtual processing, virtual memory, virtual networking, or interface and virtual storage, and may be run by a corresponding virtualization layer 1706. Different embodiments of the instance of a virtual appliance 1702 may be implemented on one or more of the VMs 1708, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1708 may be a software implementation of a physical machine that runs programs as if they were executing on a physical, non-virtualized machine. Each of the VMs 1708, and that part of the hardware 1704 that executes that VM, be it hardware dedicated to that VM and/or hardware shared by that VM with others of the VMs 1708, forms separate virtual network elements. Still in the context of NFV, a virtual network function is responsible for handling specific network functions that run in one or more VMs 1708 on top of the hardware 1704 and corresponds to the application 1702.

The hardware 1704 may be implemented in a standalone network node with generic or specific components. The hardware 1704 may implement some functions via virtualization. Alternatively, the hardware 1704 may be part of a larger cluster of hardware (e.g., such as in a data center or CPE) where many hardware nodes work together and are managed via management and orchestration 1710, which, among others, oversees lifecycle management of the applications 1702. In some embodiments, the hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1712 which may alternatively be used for communication between hardware nodes and radio units.

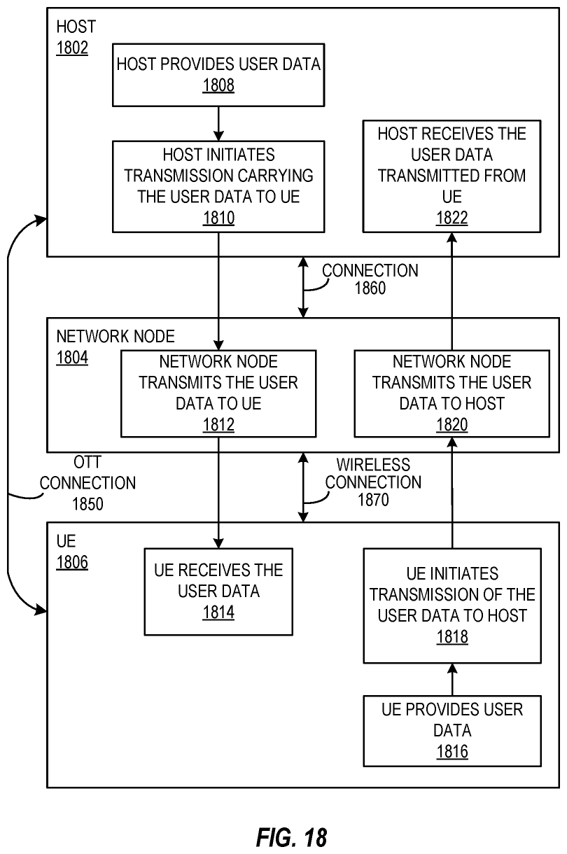

FIG. 18 shows a communication diagram of a host 1802 communicating via a network node 1804 with a UE 1806 over a partially wireless connection in accordance with some embodiments. Example implementations, in accordance with various embodiments, of the UE (such as the UE 1312A of FIG. 13 and/or the UE 1400 of FIG. 14), the network node (such as the network node 1310A of FIG. 13 and/or the network node 1500 of FIG. 15), and the host (such as the host 1316 of FIG. 13 and/or the host 1600 of FIG. 16) discussed in the preceding paragraphs will now be described with reference to FIG. 18.

Like the host 1600, embodiments of the host 1802 include hardware, such as a communication interface, processing circuitry, and memory. The host 1802 also includes software, which is stored in or is accessible by the host 1802 and executable by the processing circuitry. The software includes a host application that may be operable to provide a service to a remote user, such as the UE 1806 connecting via an OTT connection 1850 extending between the UE 1806 and the host 1802. In providing the service to the remote user, a host application may provide user data which is transmitted using the OTT connection 1850.

The network node 1804 includes hardware enabling it to communicate with the host 1802 and the UE 1806 via a connection 1860. The connection 1860 may be direct or pass through a core network (like the core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by the UE 1806 and executable by the UE's processing circuitry. The software includes a client application, such as a web browser or operator-specific “app” that may be operable to provide a service to a human or non-human user via the UE 1806 with the support of the host 1802. In the host 1802, an executing host application may communicate with the executing client application via the OTT connection 1850 terminating at the UE 1806 and the host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via the connection 1860 between the host 1802 and the network node 1804 and via a wireless connection 1870 between the network node 1804 and the UE 1806 to provide the connection between the host 1802 and the UE 1806. The connection 1860 and the wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804 in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR, or AR which it can broadcast, multicast, or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1850 between the host 1802 and the UE 1806 in response to variations in the measurement results. The measurement procedure and/or the network functionality for reconfiguring the OTT connection 1850 may be implemented in software and hardware of the host 1802 and/or the UE 1806. In some embodiments, sensors (not shown) may be deployed in or in association with other devices through which the OTT connection 1850 passes; the sensors may participate in the measurement procedure by supplying values of the monitored quantities exemplified above, or by supplying values of other physical quantities from which software may compute or estimate the monitored quantities. The reconfiguring of the OTT connection 1850 may include message format, retransmission settings, preferred routing, etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency, and the like by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

Embodiment 1: A method performed by a user equipment, UE, (408) for a wireless access network, the method comprising: determining (900) whether the UE (408) meets one or more adjusted reference signal, RS, occasion-channel reception resource proximity, ARCP, conditions for a, RS occasion, RSO, and a channel reception resource, CRR; and performing (902) one or more operational tasks based on whether the UE (408) meets the one or more ARCP conditions for the RSO and the CRR.

Embodiment 2: The method of embodiment 1 wherein determining (900) whether the UE (408) meets the one or more ARCP conditions for the RSO and the CRR comprises determining (900) whether the UE (408) meets the one or more ARCP conditions for the RSO and the CRR based on one or more rules.

Embodiment 3: The method of embodiment 1 wherein the one or more ARCP conditions comprise: (a) a condition that the RSO overlaps or partially overlaps the CRR in time; (b) a condition that the RSO is sufficiently close to the CRR in time; (c) a condition that a distance in time between the RSO and the CRR is within a first predefined or configured threshold; (d) a condition that a distance in time between the RSO and the CRR is not greater than second predefined or configured threshold; (e) a condition that a magnitude of a difference between a timing (e.g., start or end) of the RSO and a timing (e.g., start or end) of the CRR is less than a second predefined or configured threshold; or (f) any combination of two or more of (a)-(e).

Embodiment 4: The method of any of embodiments 1 to 3 wherein performing (902) the one or more operational tasks based on whether the UE (408) meets the one or more ARCP conditions for the RSO and the CRR comprises: performing (902C) at least one of a first set of operational tasks if the UE (408) does not meet the one or more ARCP conditions for the RSO and the CRR; performing (902C) at least one of a second set of operational tasks if the UE (408) meets the one or more ARCP conditions for the RSO and the CRR.

Embodiment 5: The method of embodiment 4 wherein the second set of operational tasks comprises: transmitting information about the adjustment of the RSO to a network node; and transmitting information that the one or more ARCP conditions are met for the RSO and the CRR to a network node.

Embodiment 6: The method of embodiment 4 or 5 wherein the first set of operational tasks comprises: performing or continuing to perform measurements during that RSO even if the RSO is adjusted; and/or receiving or monitoring one or more channels during the CRR (e.g., receive paging, receiving system information (e.g., MIB, SIB1, other SIBs etc.)).

Embodiment 7: The method of any of embodiments 4 to 6 wherein the second set of operational tasks further comprises: (i) not performing or not continuing to perform measurements during that RSO; (ii) receiving or monitoring one or more channels during the CRR (e.g., receive paging, receiving system information (e.g., MIB, SIB1, other SIBs etc.)); (iii) stop adjusting the RSO or postponing the adjustment of the RSO for a certain time period; (iv) prioritizing reception of channels during the CRR over performing measurements during the adjusted RSO or vice versa depending on the type of CRR; (v) refraining from receiving or monitoring a certain channel in up to G1 number of channel reception resources out of Gt number of consecutive channel reception resources; (vi) refraining from receiving or monitoring a certain channel in up to G1 number of channel reception resources during certain time period; (vii) adapting one or more measurement requirements; (viii) extending a measurement time of measurements which the UE (408) cannot perform in one or more adjusted RSO; or (ix) any combination of two or more of (i)-(viii).

Embodiment 8: The method of any of embodiments 1 to 7 wherein the wireless access network is a Non-Terrestrial Network, NTN.

Embodiment 9: The method of any of the previous embodiments, further comprising: providing user data; and forwarding the user data to a host via the transmission to the network node.

Embodiment 10: A user equipment, comprising: processing circuitry configured to perform any of the steps of any of embodiments 1 to 9; and power supply circuitry configured to supply power to the processing circuitry.

Embodiment 11: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of embodiments 1 to 9; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 12: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of embodiments 1 to 9 to receive the user data from the host.

Embodiment 13: The host of the previous embodiment, wherein the cellular network further includes a network node configured to communicate with the UE to transmit the user data to the UE from the host.

Embodiment 14: The host of the previous 2 embodiments, wherein: the processing circuitry of the host is configured to execute a host application, thereby providing the user data; and the host application is configured to interact with a client application executing on the UE, the client application being associated with the host application.

Embodiment 15: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of embodiments 1 to 9 to receive the user data from the host.

Embodiment 16: The method of the previous embodiment, further comprising: at the host, executing a host application associated with a client application executing on the UE to receive the user data from the UE.

Embodiment 17: The method of the previous embodiment, further comprising: at the host, transmitting input data to the client application executing on the UE, the input data being provided by executing the host application, wherein the user data is provided by the client application in response to the input data from the host application.

Embodiment 18: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of embodiments 1 to 8 to transmit the user data to the host.

Embodiment 19: The host of the previous embodiment, wherein the cellular network further includes a network node configured to communicate with the UE to transmit the user data from the UE to the host.

Embodiment 20: The host of the previous 2 embodiments, wherein: the processing circuitry of the host is configured to execute a host application, thereby providing the user data; and the host application is configured to interact with a client application executing on the UE, the client application being associated with the host application.

Embodiment 21: A method implemented by a host configured to operate in a communication system that further includes a network node and a user equipment (UE), the method comprising: at the host, receiving user data transmitted to the host via the network node by the UE, wherein the UE performs any of the steps of any of embodiments 1 to 8 to transmit the user data to the host.

Embodiment 22: The method of the previous embodiment, further comprising: at the host, executing a host application associated with a client application executing on the UE to receive the user data from the UE.

Embodiment 23: The method of the previous embodiment, further comprising: at the host, transmitting input data to the client application executing on the UE, the input data being provided by executing the host application, wherein the user data is provided by the client application in response to the input data from the host application.

Those skilled in the art will recognize improvements and modifications to the embodiments of the present disclosure. All such improvements and modifications are considered within the scope of the concepts disclosed herein.

1. A method performed by a user equipment (UE) for a wireless access network, the method comprising:
determining whether the UE meets one or more adjusted reference signal, RS, occasion-channel reception resource proximity (ARCP) conditions for an RS occasion (RSO) and a channel reception resource (CRR); and
performing one or more operational tasks based on whether the UE meets the one or more ARCP conditions for the RSO and the CRR, wherein performing the one or more operational tasks comprises adapting at least one measurement scaling factor to a measurement time to extend the measurement time.

2. The method of claim 1, wherein performing one or more operational tasks based on whether the UE meets the one or more ARCP conditions for the RSO and the CRR comprises performing one or more operational tasks based on whether the UE meets the one or more ARCP conditions for the RSO and the CRR when multiple RSOs are configured.

3. The method of claim 1, wherein determining whether the UE meets the one or more ARCP conditions for the RSO and the CRR comprises determining whether the UE meets the one or more ARCP conditions for the RSO and the CRR based on one or more rules.

4. The method of claim 1, wherein the one or more ARCP conditions comprise:
(a) a condition that the RSO overlaps or partially overlaps the CRR in time;
(b) a condition that a distance in time between the RSO and the CRR is within a first predefined or configured threshold;
(c) a condition that a distance in time between the RSO and the CRR is not greater than a second predefined or configured threshold;
(d) a condition that a magnitude of a difference between an RSO start time or an RSO end time of the RSO and a CRR start time or a CRR end time of the CRR is less than or equal to a third predefined or configured threshold; or
(e) any combination of two or more of (a)-(d).

5. The method of claim 1, wherein performing the one or more operational tasks based on whether the UE meets the one or more ARCP conditions for the RSO and the CRR comprises:
performing at least one of a first set of operational tasks if the UE does not meet the one or more ARCP conditions for the RSO and the CRR; and
performing at least one of a second set of operational tasks if the UE meets the one or more ARCP conditions for the RSO and the CRR.

6. The method of claim 5, wherein the second set of operational tasks comprises:
transmitting information about an adjustment of the RSO to a network node; and
transmitting information that the one or more ARCP conditions are met for the RSO and the CRR to the network node.

7. The method of claim 5, wherein the first set of operational tasks comprises:
performing or continuing to perform measurements during the RSO even if the RSO is adjusted; or
receiving or monitoring one or more channels during the CRR.

8. The method of claim 5, wherein the second set of operational tasks further comprises:
(i) not performing or not continuing to perform measurements during the RSO;
(ii) receiving or monitoring one or more channels during the CRR;
(iii) stop adjusting the RSO or postponing the adjustment of the RSO for a certain time period;
(iv) prioritizing reception of channels during the CRR over performing measurements during the adjusted RSO or vice versa depending on the type of CRR;
(v) prioritizing performing measurements during the RSO over reception of paging during the CRR;
(vi) refraining from receiving or monitoring a certain channel in up to G1 number of channel reception resources out of Gt number of consecutive channel reception resources;
(vii) refraining from receiving or monitoring a certain channel in up to G1 number of channel reception resources during a certain time period;
(viii) adapting one or more measurement requirements;
(ix) extending a measurement time of measurements which the UE cannot perform in one or more adjusted RSOs; or
(x) any combination of two or more of (i)-(ix).

9. The method of claim 7, wherein receiving or monitoring the one or more channels during the CRR comprises receiving paging or receiving System Information (SI).

10. The method of claim 5, wherein the UE obtains the first set of operational tasks or the second set of operational tasks based on one or more rules.

11. The method of claim 10, wherein the one or more rules comprise:
(i) the UE receives paging even if an adjusted or shifted RSO is within Z1 time resources before a paging occasion or within Z2 time resources after the paging occasion;
(ii) the UE receives paging even if the adjusted or shifted RSO partially or fully overlaps with the paging occasion; or
(iii) the UE receives System Information, SI, even if the adjusted or shifted RSO is within Z3 time resources before an SI reception occasion or within Z4 time resources after the SI reception occasion; or
(iv) the UE receives the SI even if the adjusted or shifted RSO is partially or fully overlapping with the SI reception occasion.

12. The method of claim 11, wherein the adjusted or shifted RSO comprises a Synchronization Signal Block (SBB) Measurement Timing Configuration (SMTC) occasion.

13. The method of claim 9, wherein the SI comprises a Master Information Block (MIB) System Information Block 1 (SIB1) or other System Information Block, SIB.

14. The method of claim 1, wherein the wireless access network is a Non-Terrestrial Network, NTN.

15. A user equipment (UE) comprising:
transmitter circuitry; and
processing circuitry associated with the transmitter circuitry, the processing circuitry configured to cause the UE to:
determine whether the UE meets one or more adjusted reference signal (RS) occasion-channel reception resource proximity (ARCP) conditions for an RS occasion (RSO) and a channel reception resource (CRR); and
perform one or more operational tasks based on whether the UE meets the one or more ARCP conditions for the RSO and the CRR, wherein performing the one or more operational tasks comprises adapting at least one measurement scaling factor to a measurement time to extend the measurement time.

16. The UE of claim 15, wherein determining whether the UE meets the one or more ARCP conditions for the RSO and the CRR comprises determining whether the UE meets the one or more ARCP conditions for the RSO and the CRR based on one or more rules.

17. The UE of claim 15, wherein the one or more ARCP conditions comprise:
(a) a condition that the RSO overlaps or partially overlaps the CRR in time;
(b) a condition that a distance in time between the RSO and the CRR is within a first predefined or configured threshold;
(c) a condition that a distance in time between the RSO and the CRR is not greater than a second predefined or configured threshold;
(d) a condition that a magnitude of a difference between a start time or an end time of the RSO and a start time or an end time of the CRR is less than or equal to a third predefined or configured threshold; or
(e) any combination of two or more of (a)-(d).

18. The UE of claim 15, wherein performing the one or more operational tasks based on whether the UE meets the one or more ARCP conditions for the RSO and the CRR comprises:
performing at least one of a first set of operational tasks if the UE does not meet the one or more ARCP conditions for the RSO and the CRR; and
performing at least one of a second set of operational tasks if the UE meets the one or more ARCP conditions for the RSO and the CRR.

19. The UE of claim 18, wherein the second set of operational tasks comprises:
transmitting information about an adjustment of the RSO to a network node; and
transmitting information that the one or more ARCP conditions are met for the RSO and the CRR to the network node.

20-21. (canceled)

22. The method of claim 1, wherein performing one or more operational tasks based on whether the UE meets the one or more ARCP conditions for the RSO and the CRR comprises performing one or more operational tasks based on whether the UE meets the one or more ARCP conditions for the RSO and the CRR when multiple RSOs are configured.
